(19) United States
(12) Patent Application Publication
(10) Pub. No.: US 2025/0273098 A1
(43) Pub. Date: Aug. 28, 2025

(54) FABRIC AND ITS USE IN A RETRACTABLE BANNER ASSEMBLY

(71) Applicant: Andrew Eric Reiner, Park City, UT (US)

(72) Inventor: Andrew Eric Reiner, Park City, UT (US)

(21) Appl. No.: 19/061,402

(22) Filed: Feb. 24, 2025

Related U.S. Application Data
(63) Continuation-in-part of application No. 18/587,296, filed on Feb. 26, 2024.

(51) Int. Cl. G09F 15/00; G09F 17/00

(52) U.S. Cl. CPC G09F 15/0062; G09F 17/00

(57) ABSTRACT

A new and improved fabric, preferably a rollable fabric, having improved having dimensional stability reducing fabric surface contour distortions while promoting the smooth rolling and unrolling. In a preferred embodiment, the rollable fabric is used as banner in a retractable banner assembly having reduced fabric surface contour distortions, promoting smooth unrolling and retraction, and reduced unevenness on deployment. The retractable banner assembly using the rollable fabric of the invention is useful in residential, commercial, and public spaces, indoors and outdoors, to route persons and/or inhibit access to designated areas and effectively impart clear messaging provided thereon.

### CROSS REFERENCE TO RELATED APPLICATIONS

This patent application is a continuation-in-part of U.S. patent application Ser. No. 18/587,296, filed on Feb. 26, 2024, and titled “Improved Retractable Banner Assembly.” The entirety of the foregoing application is hereby incorporated by reference.

### TECHNICAL FIELD

This invention relates generally to rollable fabrics for use in retractable banner assemblies and similar devices or applications. More specifically, it concerns an improved rollable fabric with enhanced dimensional stability and other properties that reduce drooping, sagging fabric evenness and surface irregularities. These improvements result in a banner that rolls and unrolls smoothly while maintaining consistent orientation, sufficiently reduced tension, and minimized distortion during repeated deployments. The improved rollable fabric, when used in a retractable banner assembly is suitable for residential, commercial and public applications, both indoors and outdoors. It can be used to guide foot traffic, control or restrict access, direct persons through designated areas, and display information or messaging in a visually appealing manner.

### BACKGROUND OF THE INVENTION

Safety gates, particularly child and pet safety gates, are well known in the art for use in inhibiting or preventing access to residential areas such as kitchens, stairways, basements, garages, and the like, which may be unsafe or undesirable for children or pets. They typically comprise a plurality of cooperating and substantially rigid gate sections, comprised of wood, plastic, metal, and the like, and are generally horizontally extensible and retractable specifically within corresponding narrow entryways such as between doorjambs, opposed walls, balustrade uprights, and the like. They are also commonly provided on the ends thereof with compressible buffer stops comprising elastomeric material or other suitable spring mechanisms, which when compressed and then released, function to effectively set the corresponding gate or gate sections against displacement between the respective opposed fixed extremes defined by the narrow entryways. Additional safety latches have been used to further secure the relative positions of the corresponding gate sections and prevent inadvertent or undesired disengagement of the same following installation. To remove the gates after installation, the safety latches, if any, must first be disabled or released whereupon the buffer stops may be compressed (generally by applying lateral pressure to the same) to temporarily relieve applied tension on the opposed fixed extremes of the corresponding entryways. The rigid gate sections may then be sufficiently retracted (typically slid back) for the gate or gate system to be removed.

Variations of the above safety gates have included flexible fabric sections that are similarly extensible and retractable. However, these fabric sections, due to their physical characteristics and resulting lack of sufficient dimensional stability, exhibit physical fabric distortions including sagging, rippling, buckling, drooping, curling, and the like. These distortions result in uneven fabric surfaces that not only prevent the safety gate from being smoothly rolled and unrolled but also impair the ability to see the communications on these fabrics upon deployment. These fabric sections also comprise structures and orientations that are unsuitable for printing, let alone higher fidelity printing on one or both sides thereof, as is typically desired in commercial applications. Specifically, most standard gates are made of a fabric that fails to provide a sufficiently continuous surface with a sufficiently low texture and adequate opacity for blocking a sufficient amount of visible light required for high quality printing and display thereof. Such flexible safety gates with these fabric sections have thus been found to be both functionally limited, if not inoperative, and aesthetically unappealing. While such banners may, despite these failings, be arguably suitable for their limited and specific intended use of blocking passage, they are neither designed nor intended to span greater distances in the vertical and/or horizontal directions. The additional fabric required for these lengths and heights results in increased weight further exacerbating the existing fabric distortions, reducing the fabric sections overall dimensional stability, and hindering the operability of retractable mechanism for rolling and unrolling.

Safety gates have similarly been used in retail, warehouse, and other environments to temporarily prevent access to selected areas, sometimes to block or inhibit access through corresponding entryways such as shopping aisles, and the like, as may be defined, for example, by shelving and storage racks such as pallet rack systems and assemblies. Like the above-referenced child safety and pet gates, these gates, including variations having flexible fabric sections that are engineered for their specific purposes and lack the physical characteristics and sufficient dimensional stability for preventing fabric distortions and result in these gates from operating smoothly, and impairing the quality of print on them. These specific use safety gates are constructed of fabrics that have highly textured surfaces and/or fail to block enough light making it difficult to print on the surfaces of the fabric. Again, the fabrics used in these specific safety gates are neither designed nor intended for use as rollable banners for use in applications requiring a greater span, and for printing thereon.

Stanchion top retractable belts, which are relatively narrow, are commonly used in public and private waiting areas and queue systems such as transportation hubs (airports, train stations, bus stations, etc.), museums, event centers (theatres, concert halls, etc.), ticket offices, and similar locations for traffic control. A typical stanchion top retractable belt consists of a small top cap affixed or attachable to an upright stanchion, which is supported by a weighted or fixed base. The belt or tape is usually made of a heavy-duty fabric or webbing material that extends and retracts as needed. These top mounted retractable belts are primarily designed to guide and direct pedestrian movement along designated pathways. However, these belts do not effectively restrict ingress or egress, as individuals can easily duck under or step over them. Additionally, when deployed, over short or extended distances, they are prone to distortions and sagging due to the weight of the webbing material. Furthermore, the limited and narrow surface area and material properties make them challenging to print on, restricting their effectiveness for conveying messaging or branding.

Various gates, barriers and banners have similarly been used in preventing access to specified work, pedestrian, and recreation areas such as pools and the like and to define enclosures. However, the issue remains that these flexible banners, and even those upon which printing is possible, are not suitable for high quality printing in which the printed subject matter is clear, aesthetically pleasing and the fabric is free from distortions. These deficiencies are the result of the quality of the surface of these fabric sections and the physical distortions of sagging, rippling, buckling, drooping, and curling. These fabrics do not have a balance of physical properties resulting in these fabric distortions and unacceptably hindering the smooth extension and retraction, particularly upon their repeated use.

In summary, rollable fabrics in use, particularly when used as banners in retractable banner assemblies, generally result in retractable banner assemblies operating poorly. Heretofore, very little innovation has been applied to improve either the fabric generally or the fabric as used in such an assembly specifically, both of which are a focus of the present invention. In the absence of such improvements, conventional retractable banner assemblies have been implemented to direct foot traffic but have been limited in height and length due to the referenced distortions and thus unsuitable to effectively impart clear communications such as the display of high-quality graphics and messaging. Vertically disposed retractable banner systems have been deployed with the intent to display aesthetically pleasing graphics, but the fabrics used lack of dimensional stability and resulting fabric distortions have similarly limited their use and effectiveness. This invention is directed to banners which deploy vertically, horizontally or in any orientation. Such implementations generally present competing mechanical property objectives. Namely, the rollable fabric must be sufficiently flexible to smoothly roll and unroll for stowage and deployment, yet sufficiently stiff to provide the needed dimensional stability to retain its shape with reduced distortions across the space between the supports for the banner. More specifically, the fabric must have a balance of sufficient stiffness and dimensional stability to resist these distortions, namely, sagging, rippling, buckling, drooping and curling, all of which distortions result in unevenness when the banner is rolled, stowed and/or displayed. In addition, the banner must be of a fabric that is sufficiently light to avoid distortions caused by the weight of the fabric, have sufficient stiffness and be sufficiently smooth and with a continuous display surface, sufficiently low texture and adequate opacity for blocking sufficient visible light for enabling higher quality printing on one or both sides, and repeatable and smooth forces when used in combination with a retractable banner system. Horizontally disposed rollable banner assemblies wherein the banner, upon deployment, spans a horizontal distance with support only at its ends without interim support, as contemplated by the present invention, pose a particular challenge for balancing the above properties.

Existing off-the-shelf and custom developed banner fabrics—including various mesh variants, woven materials, layered and multi-layered films, vinyl, and other coated or laminated structures--have been used in retractable banner assemblies. However, these materials perform poorly when deployed, as they lack the necessary balance of properties to remain flat and free from physical distortions, particularly for repeated deployments, making them unsuitable for such applications. Additionally, these fabrics often fail to provide the clarity needed for high-quality printing, resulting in messaging that appears distorted or aesthetically unappealing. Many of these materials were not originally designed for use in retractable banner systems, which explains their inconsistent performance in such applications. Even fabrics specifically marketed for retractable banners tend to underperform, particularly in horizontally deployed systems. Available fabrics often suffer from key deficiencies. Some are too heavy, causing banners made from these fabrics to sag and collapse under their own weight. Others, while not excessively heavy, lack sufficient stiffness and dimensional stability, making them susceptible to rippling or waviness when small variations in deployment force occur. Many existing fabrics also lack adequate opacity, allowing printing on one side to be visible form the other, which reduces legibility and aesthetic appeal. Furthermore, currently available fabrics do not achieve the necessary balance of stiffness, weight, and opacity, among other critical properties, required for effective use, including in a retractable banner system. Because of these limitations, there is a need for an improved rollable fabric that overcomes these deficiencies while maintaining structural integrity, visual clarity, and reliable extension and retraction.

Accordingly, there is a need for an improved rollable fabric for use in a retractable banner assembly, featuring an optimized balance of physical characteristics, including dimensional stability, stiffness, weight and other key properties. These improvements promote smooth rolling and unrolling, enabling the fabric to spool, wrapping multiple times without issues. Upon deployment, the fabric will unfurl smoothly, either fully or partially, while minimizing or eliminating distortions.

Further, there is a need for an improved rollable fabric in some embodiments that is both aesthetically pleasing and functionally operative to effectively impart aesthetically pleasing communications with no or minimal distortions.

Still further, there is a need for an improved rollable fabric in other embodiments to have a sufficiently smooth and continuous printing surface which blocks sufficient visible light as necessary to promote high quality printing of communications and viewing thereof.

Yet still further, there is a need for such a retractable banner assembly with an improved rollable fabric that may be implemented alone or in combination with other such assemblies for defining one or more pathways in residential, commercial, and/or public spaces, indoors and outdoors, to route people through such pathways, and/or to block or otherwise inhibit access to designated areas.

### SUMMARY OF THE INVENTION

It is a principal aspect of the present invention to provide an improved rollable fabric, particularly for use in a retractable banner assembly, as well as a retractable banner assembly incorporating such an improved rollable fabric. The fabric exhibits an optimized balance of physical characteristics, including dimensional stability, weight, stiffness and other key properties, to minimize distortions and ensure smooth rolling and unrolling during deployments, with significantly reduced distortions such as sagging, rippling, buckling, drooping, curling, and similar deformations. The preferred, more preferred, and most preferred ranges of various properties and characteristics disclosed herein are exemplary and based on the available knowledge at the time of filing, including limited testing of full and partial fabric samples (e.g., hand samples) in varying orientations, which in some cases included deployment in a horizontally oriented retractable banner assembly in accordance with the present invention. However, what is considered preferred, more preferred, or most preferred among the properties and characteristics of the embodiments disclosed in this application may vary depending on a variety of factors, including anticipated use cases, cost considerations, and the overall balance of properties and characteristics needed to achieve the desired outcome.

In one embodiment, the present invention is directed to a retractable banner assembly comprising a rotatable elongated mounting rod and a banner, wherein the banner comprises a rollable fabric that is directly or indirectly couplable to the mounting rod. The rollable fabric exhibits a stiffness greater than approximately 17 TABER Stiffness Units, as measured in either an X direction or M direction, or both directions, and has an areal density less than approximately 620 g/m².

In one embodiment, the rollable fabric of the invention has a stiffness in the X direction ranging from approximately 17 to 190 TABER Stiffness Units, or alternatively, from approximately 17 to 120 TABER Stiffness Units.

In one embodiment, the rollable fabric of the invention has a stiffness in the M direction ranging from approximately 17 to 32 TABER Stiffness Units.

In another embodiment, the rollable fabric of the invention has an areal density ranging from approximately t 260 g/m² to 620 g/m².

In another embodiment, the rollable fabric of the invention has a bending length greater than approximately 3.5 cm in the X direction, the M direction, or both.

In one preferred embodiment, the rollable fabric exhibits a stiffness greater than approximately 5 TABER Stiffness Units, as measured in the M direction, and preferably within the range of 5 to approximately 32 TABER Stiffness Units.

In yet another embodiment, the rollable fabric of the invention has a stiffness ratio, measured in TABER Stiffness Units, of the X direction to the M direction that is greater than or equal to approximately 1.3 to 1, preferably greater than or equal to approximately 1.5:1, more preferably greater than or equal to approximately 1.75:1, and most preferably greater than or equal to approximately 2:1.

In the embodiments above the rollable fabric has a crease recovery greater than approximately 90 degrees as measured in the X direction, the M direction, or both, and/or an opacity ranging from approximately 90% to 100%.

In one embodiment, the invention is directed to a rollable fabric for use as a retractable banner in a retractable banner assembly, the rollable fabric exhibits a stiffness greater than approximately 17 TABER Stiffness Units, preferably greater than approximately 18 TABER Stiffness Units, and more preferably greater than approximately 20 TABER Stiffness Units, as measured in either the X direction, the M direction, or both, and/or a stiffness ranging from approximately 5 to 32 TABER Stiffness Units, as measured in the M direction, and a stiffness ranging from approximately 5 to 32 TABER Stiffness Units, as measured in the X direction and the M direction, and an areal density less than approximately 620 g/m², and preferably ranging from approximately 260 g/m² to less than 620615 g/m².

In another embodiment, the invention is directed to a retractable banner assembly comprising a rotatable elongated mounting rod and a banner, the banner comprising a rollable fabric couplable directly or indirectly to the rotatable elongated mounting rod, wherein the rollable fabric has a stiffness in an M direction ranging from approximately 10 TABER Stiffness Units to 32 Taber Stiffness Units. In one embodiment, the rollable fabric has an areal density ranging from approximately260 g/m² to less than 620 g/m², and/or a stiffness in the M direction ranging from approximately 12 to 32 TABER Stiffness Units.

In one embodiment, the invention is directed to a rollable fabric having a stiffness ratio in the X direction to the M direction, as measured in TABER Stiffness Units, of 1.3 to 1 or greater, and/or a bending length greater than 3.5 cm in the X direction, M direction, or both.

In yet another embodiment, the invention is directed to a retractable banner assembly comprising a rotatable elongated mounting rod and a banner, wherein the banner comprises a rollable fabric that is directly or indirectly couplable to the mounting rod. The rollable fabric has a bending length greater than approximately 3.5, 4 cm or 4.5 cm or 5 cm or 5.5 cm or 6 cm or 6.5 cm, as measured in the X direction, the M direction, or both. Additionally, the fabric has a stiffness, as measured in the M direction ranging from approximately 5 to 32 TABER Stiffness Units. In a preferred embodiment, the rollable fabric has a bending length ranging from approximately 3.5 cm to about 22 cm, as measured in the X direction, the M direction, or both. Alternatively, the bending length may range from approximately 8.5 cm to about 22 cm in the X direction, the M direction, or both, or from approximately 10 cm to about 22 cm, as measured in either the X direction, the M direction, or both.

In another embodiment, the retractable banner assembly comprises a banner, wherein the banner includes a rollable fabric having a bending length in the X direction ranging from approximately 10 cm to about 22 cm, a bending length in the M direction ranging from approximately 6 cm to 22 cm, and an areal density less than approximately 620 g/m². In a further embodiment, the rollable fabric of the invention has a stiffness in the X direction, M direction, or both, ranging from approximately 14 to 120 TABER Stiffness Units, or alternatively ranging from approximately 17 to 120 TABER Stiffness Units in the X direction, M direction, or both.

In yet an embodiment, the invention is directed to a banner assembly comprising a banner, wherein the banner includes a rollable fabric having a ratio of bending length in the X direction to the M direction of greater than or equal to 1.3 to 1.

In one embodiment, the rollable fabric for use as a retractable banner of the invention has a printable front surface and an opposing back surface with a surface texture of less than approximately 10 micrometers, preferably less than 5 micrometers, more preferably less than 3 micrometers, and still more preferably less than 1 micrometers. Additionally, the fabric has an opacity greater than approximately 90%.

In another embodiment, the invention is directed to a retractable banner assembly comprising a rotatable elongated mounting rod and a banner, wherein the banner comprises a rollable fabric that is directly or indirectly couplable to the mounting rod. The rollable fabric has a ratio of Flexural Rigidity-Conversion (FRc), measured in an X direction or an M direction, to areal density (g/m²) that is equal to or greater than 5.1 to 1 or equal to or greater than 6.1 to 1. In one embodiment, the rollable fabric has a stiffness in the M direction ranging from approximately 5 to 32 TABER Stiffness Units and/or an areal density ranging from approximately 260 g/m² to less than 620 g/m².

In another embodiment, the rollable fabric of the invention has a flexural rigidity-formula (FRf), measured in the X direction, M direction, or both, of greater than approximately 2100 μN-m.

A further aspect of the invention to provide a retractable banner assembly incorporating the improved rollable fabric, wherein the assembly may be readily interconnected with one or more similar assemblies, or with fixed or portable end points. this interconnectivity allows for the formation of defined pathways to guide or route persons or vehicles and/or to restrict access to designated areas.

In carrying out these and other objects, features, and advantages of the present invention, there is provided a retractable banner assembly incorporating an improved rollable fabric that is coupled directly or indirectly to a rotatable elongate mounting rod. The rollable fabric is sufficiently high in flexural rigidity and low in areal density, providing the dimensional stability necessary to smoothly roll and unroll while maintaining a substantially flat orientation upon deployment. Additionally, the fabric imparts one or more of the aforementioned advantages of the invention.

These and other objects, features, and advantages of the present invention will be more readily apparent by reference to the following brief description of the drawings and best modes for carrying out the invention. It is to be understood that the drawings and description are solely for exemplary purposes and are not intended to limit, and do not limit, the scope of the invention as set forth in the accompanying claims.

### BRIEF DESCRIPTION OF DRAWINGS

FIG. 1 is a perspective diagram of one preferred embodiment of the retractable banner assembly and improved rollable fabric of the present invention shown with the fabric unrolled and partially extended from a spool for use “as is” or for use as a banner, optionally in a retractable banner assembly.

FIG. 2 is a schematic illustrating a preferred fabric stiffness testing method used in accordance with the present invention.

FIG. 3 is a perspective diagram of one preferred but not required embodiment of the improved rollable fabric of the present invention wherein the fabric includes a substrate comprising a plurality of stiffening fibers which may be monofilament yarns.

FIG. 4 is a perspective diagram of an additionally preferred but not required embodiment of the improved rollable fabric of the present invention wherein the fabric comprises an extruded substrate.

FIG. 5 is a perspective diagram of yet an additional preferred but not required embodiment of the improved rollable fabric of the present invention wherein the fabric comprises a non-woven substrate assembly.

FIG. 6 is a perspective diagram of still further an alternative embodiment of the improved rollable fabric of the present invention wherein the fabric comprises a laid-scrim substrate.

### DETAILED DESCRIPTION OF THE INVENTION

For background purposes, those skilled in the art will recognize that fibers as may be used in a rollable fabric, generally fall into 3 categories: (1) animal, (2) plant, and (3) synthetic. Wool, cotton, and polyester are representative corresponding examples of each of the foregoing. Synthetic fibers may further be classified as staple (also known as cut to length fibers), tow (a continuous rope of fibers consisting of many filaments loosely joined side-to-side, and filament (a continuous strand consisting of 1 or more filaments). Yarn is typically created by “spinning” fibers. Knit fabrics may be formed through weft or warp knitting processes. The former often involves a single yarn or thread that is repeatedly looped with itself or with other previously looped yarns but can involve more. The latter involves many individual yarns or threads that are interlaced. Woven fabrics are created using several longitudinal (machine (M) direction) yarns (interchangeably referred to as warp yarns) and wefts, or latitudinal (cross-machine (X) direction) yarns (also interchangeably referred to as filling yarns). Multiple yarns interlace and thus cross each other, typically at right angles, like a basket. Non-woven fabrics, in contrast, generally comprise cut to length or continuous fibers that have been bonded together using any suitable manufacturing process including any combination of heat, chemical, and/or mechanical treatment and without weaving or knitting.

Fabrics have physical and mechanical properties, including weight or areal density, stiffness, flexural rigidity, bending length, crease recovery, thread density for knit fabrics, ends, or picks per unit length for woven fabrics, opacity, visible transmittance, cover factor, show-through, and surface topography. A balance of these and other properties can be useful in describing a fabric's performance characteristics as discussed in further detail below as relevant to the present invention.

Weight, more specifically areal density, when used in reference to fabrics and referenced herein according to the invention, is a two-dimensional measure of the mass of a fabric per unit area, generally expressed in grams per square meter (g/m²) or ounces per square yard. In the context of a fabric, areal density is an important factor that is typically interrelated to other physical properties of the fabric including strength, durability, thickness, and stiffness. Areal density is affected by many factors including the method and material of construction which may include among other variables, different fiber types, yarn counts, weave or knit structures, substrates, and substrate assemblies, and finishing processes. The areal density of a fabric is typically calculated by weighing an area of the fabric and then dividing the weight by the area. Areal density may be used to compare fabrics or elements of different constructions and fiber types.

In one embodiment, the rollable fabric has an areal density of less than 625 g/m², preferably in the range of 260 g/m² to about 620 g/m², more preferably in the range of 300 g/m² to less than about 620 g/m², even more preferably in the range of from 300 g/m² to about 610 g/m², and most preferably from 350 g/m² to 600 g/m². In yet another embodiment, the rollable fabric of the invention has an areal density in the ranges of from about 350 g/m² to 600 g/m², or in the range of from about 350 g/m² to about 570 g/m², or in the ranges of from about 350 g/m² to about 550 g/m², or in the range of from about 400 g/m² to about 525 g/m². In still yet another embodiment, the areal density is in the ranges from about 550 g/m² to 625 g/m² or about 525 g/m² to about 550 g/m² or about 500 g/m² to about 525 g/m² or about 450 g/m² to about 500 g/m² or about 350 g/m² to 450 g/m².

Fabric stiffness is related to a fabric's flexural properties, namely a fabric's tendency to bend or flex under a specified force or resist the same. These flexural properties can be assessed by measurement of the amount of deflection or bending generally, the specific force required to bend the fabric to a certain degree, as well as the fabric's ability to recover its shape after being so bent or flexed. Stiffness may be affected by many factors. Adding material, which adds areal density, may result in the fabric being more resistant to bending and thus having greater stiffness. Conversely, the additional weight may result in the fabric being more susceptible to deflection as it bends under its own weight. As those skilled in the art will recognize, flexural rigidity of the fabric of the invention may be assessed in several ways: (i) using a TABER test measured in Taber Units, (ii) a calculated flexural rigidity (FRc) using a direct conversion of Taber Units, and (iii) a formula for flexural rigidity (FRf) derived from bending length determined using ASTM D-1388, Option A, and areal density. All of which will be discussed in further detail below in this patent specification.

Bending length is an important characteristic of a fabric that governs its applications. Fabrics with high bending length tend to be stiffer and lack good drape and flexibility which is desirable in some applications but not the current innovation. Bending length is defined as half the falling length as measured using the Cantilever test discussed below (sometimes synonymously called the ‘overhang length’) wherein a fabric falls under its own weight beyond a cantilever point to a specific angle. The bending length is typically measured in centimeters. There are many factors that impact bending length, primarily including flexural rigidity and areal density as referenced above. Some factors that affect flexural rigidity and areal density include, for example, yarn properties, weaving parameters, and processing parameters.

In one embodiment, the rollable fabric of the invention has a bending length greater than approximately 3.5 cm, or even greater than approximately 4 cm, as measured in the X direction, the M direction, or both. In another embodiment, the bending length is within the range of approximately 3.5 cm to 22 cm, or approximately 4 cm to about 22 cm, or approximately 4.5 cm to 20 cm, or approximately 5.5 cm to 20 cm, or approximately 6 cm to 18 cm, or approximately 6.5 cm to about 18 cm, as measured in the X direction, M direction, or both. In yet another embodiment, the rollable fabric has a bending length within the ranges of approximately 3.5 cm to 22 cm, approximately 8.5 cm to 22 cm, or approximately 10 cm to 22 cm, as measured in the X direction, M direction, or both. Additionally, the fabric may have a stiffness as measured in the M direction ranging from approximately 5 to 32 TABER Stiffness Units, and/or a stiffness ranging from approximately 14,17,18 or 20, to 120 TABER Stiffness units. In one embodiment, the rollable fabric of the invention has a stiffness in the M direction ranging from approximately 7 to 30 TABER Stiffness Units or alternatively ranging from approximately 9 to 28 Taber Stiffness Units or alternatively ranging from approximately 11 to 26 TABER Stiffness Units.

In another embodiment, the rollable fabric has a bending length in the M direction greater than 3.5 cm, 4 cm, 5 cm, or 6.5 cm, preferably ranging from approximately 3.5 cm to 22 cm, and more preferably from approximately 3.5 cm to 20 cm. The bending length in the X direction is such that the ratio of bending length in X direction to the M direction is equal to or greater than 1.3:1, more preferably equal to or greater than 1.5:1, more preferably equal to or greater than 1.75:1, and most preferably equal to or greater than 2:1. In some embodiments, the rollable fabric has an areal density ranging from approximately 2600 g/m² to less than 620 g/m², preferably from approximately 375 g/m² to about 600 g/m². In certain embodiments, the rollable fabric is highly stiff in one direction, to the extent that measuring bending length may be difficult, while in the other direction, the bending length is preferably within the range of approximately 3.5 cm to 22 cm, more preferably 3.5 cm to 20 cm, or even 4 cm to about 20 cm. In some preferred embodiments, the rollable fabric is highly stiff in the X direction, while maintaining sufficient flexibility to allow for rolling and unrolling. In this embodiment, the stiffness in the M direction is less than 32 TABER Stiffness Units, preferably ranging from approximately 5 to 30 TABER Stiffness units, where in some embodiments, the upper end of the stiffness range may be 25, 26, 27, 28 or 29 TABER Stiffness Units.

In another embodiment, the invention is directed to a retractable banner assembly comprising a rotatable elongate mounting rod and a rollable banner coupled directly or indirectly to the mounting rod. The banner comprises a rollable fabric having an areal density less than 650 grams per square meter and a flexural rigidity value greater than 6.5 TABER Stiffness Units, as measured in at least one direction. In yet another embodiment, the invention is directed to a retractable banner assembly comprising a rotatable elongate mounting rod and a rollable banner coupled directly or indirectly to the mounting rod. The ratio of flexural rigidity, measured in at least one direction, to areal density, is greater than 0.019 TABER Stiffness Units per gram square meter. In one embodiment, the retractable banner assembly includes a banner comprising a plurality of X-direction stiffening fibers. In yet another embodiment, the invention is directed to a retractable banner assembly comprising a rotatable elongate mounting rod and a rollable banner coupled directly or indirectly to the mounting rod. The banner has a bending length greater than 6.5 cm as measured in at least one direction.

A fabric's ability to return to its original shape after being rolled or subjected to a bending or creasing force during use can also be measured and is referred to herein as “crease recovery”. Fabrics with adequate crease recovery can maintain an aesthetically pleasing appearance and continue to function properly for their intended use after being subjected to such forces. Again, as those skilled in the art will recognize, crease recovery is measured in degrees of angle recovery ranging from 0 degrees indicating no recovery to 180 degrees corresponding to full recovery, using a suitable instrument and test. In this test, a load is applied to a bent specimen while the specimen is maintained in a creased form for a specified time. After the time expires, the load and thus the force is removed, and the specimen is given a set time to “recover”. After the recovery time expires, the crease angle is measured.

Crease recovery may be measured using the methodology and test equipment detailed in one of several applicable standards including by way of example, and not limitation, IS 4681:1981, ISO 2313, and AATCC66, all of which are known to those of skill in the art. Crease recovery may be measured using a popular instrument known as a Shirley crease recovery tester. This instrument comprises a circular dial which includes a clamp for holding the specimen. A knife edge and an index line for measuring the recovery angle are disposed directly under the center of the dial. Crease recovery is determined according to this measured recovery angle wherein a recovery angle of 0 degrees corresponds to no crease recovery and a recovery angle of 180 degrees corresponds to full crease recovery. Crease recovery depends on a variety of factors including, but not limited to, material construction, twist of yarn, pressure, and time as well as tensile, compressive, flexing, and torsional properties, as applicable. For the purposes of the current innovation crease recovery preferably in some embodiments, will exceed 80 degrees, more preferably it will exceed 90 degrees, most preferably will exceed 100 degrees and optimally it will exceed 110 degrees in the X direction, the M direction, or both directions. Dimensional stability may also be enhanced and longevity of use of the fabric extended wherein the rollable fabric has a crease recovery greater than approximately 90 degrees as measured in at least one direction.

For the purposes of the current invention in one embodiment, the crease recovery, as described earlier in this disclosure, is preferably greater than approximately 80 degrees, more preferably greater than 90 degrees, more preferably greater than 100 degrees and optimally it is greater than 110 degrees. In one embodiment, the rollable fabric has a crease recovery of greater than approximately 90 degrees, preferably greater than 100 degrees, and most preferably ranging from 125 degrees to 175 degrees, and even more preferably ranging from 150 degrees to 170 degrees.

Ends per unit length and picks per unit length are measurements used to describe the structure of a woven fabric in terms of the number of warp yarns (ends) and weft yarns (picks) per applicable linear measurement unit of the fabric. For example, in the imperial system, ends or picks are counted per inch and appropriately termed ends per inch (EPI) and picks per inch (PPI) as applicable. Similarly, in the metric system, ends and picks are counted per centimeter and termed ends per centimeter (EPC) and picks per centimeter (PPC). As the number of fibers used in the construction of a fabric increases in both the warp and weft directions, the stiffness of the fabric in the weft direction tends to increase accordingly and generally the areal density as well. However, increases in number of fibers may, depending on the configuration and materials used, cause the stiffness in the warp direction to decrease.

Opacity is a measure of how much visible light is blocked by a specific fabric sample. Opacity is typically expressed as a percentage between 0% and 100% where a higher value indicates greater opacity (i.e., greater blocking of light). A fabric with high opacity, or more appropriately a high opacity value, will block more light and be less transparent than a fabric with a lower opacity value. A fabric that blocks all light is considered fully opaque. Conversely, a fabric that allows all light to pass through without scattering or distorting the light such that objects on the other side are clearly visible, is considered fully transparent. A fabric that allows some degree of light transmission but is not fully transparent in that it scatters and diffuses light to some extent so that objects on the other side are not clearly visible is deemed translucent. Visible transmittance, in contrast to opacity, is a measure of the amount of visible light that is transmitted through a fabric sample. It can similarly be expressed as a percentage between 0% and 100%, where a higher value indicates greater light transmission. A fabric with a high visible transmittance will allow greater light to pass through it, while a fabric with low visible transmittance will block greater light. For the purposes of the current invention in which the fabric banner is intended to be printed on at least one side and suitable to be viewable from both sides, the opacity must be sufficient to block visibility of the image printed on one side when viewing from the other side. Printable banners are used inside and outside, in direct light and in ambient light, and must have suitable opacity for these different lighting conditions.

For purposes of the present invention, opacity may be measured using different methods to determine the percentage of light blocked by the fabric when in front of the specified light source compared to the light emitted when not blocked by the fabric. ISO standard test method ISO 2471—Determination of Opacity (Diffuse Reflectance method) is one method. Other methods directed to determining the percentage of light which passes through the banner may also be used. See also, for example, American Association of Textile Chemists and Colorists Test Methods AATCC TM 148: Light Blocking Effect of Textiles: Photodetector Method and AATCC TMTM 203: Light Blocking Effect of Textiles: Spectrophotometric Method, both of which may be applicable to the present invention. Given the different opacity testing methods, in any method of testing, if the opacity exceeds 80%, it is within the purview of the inventive concept disclosed herein. For the avoidance of any confusion, the specific testing method to determine opacity for the invention disclosed herein is defined in Fabric Opacity Testing Standard (FOTS-200L) as follows:

Objective: To determine the opacity of a fabric sample by measuring the amount of light passing through the fabric under controlled illumination of 200 lux.

### Equipment and Materials

1. 200 Lux Light Source: Light source capable of providing a consistent illumination of 200 lux.
2. Lux Meter: To measure the illuminance level before and after light passes through the fabric.
3. Light Tunnel: Enclosure to direct light from the light source to the fabric, minimizing external light interference and ensuring uniform light distribution. The tunnel is ideally cylindrical but can be square and should have a non-reflective interior. The dimensions of the light tunnel are dictated by the distance which the light source must be maintained from the fabric and the size of the fabric samples to be tested. It is anticipated that the light source will be positioned 24 to 36 inches from the fabric, so the tunnel should be at least 36 inches in length. A good fabric sample size is in the range of 12-14 inches so the outer walls of the tunnel should be dimensioned accordingly to be within the outer borders of the sample in the range of 8-10 inches.
4. Fabric Holder: A frame or stand to securely hold fabric sample in place at the end of the tunnel during testing, ensuring no light leakage around the edges between the light tunnel and the fabric.
5. Standardized Background: A non-reflective, matte black background placed behind the fabric and lux meter testing location during testing, minimizing reflection and light interference.
6. Control Fabric: Fabric with a known opacity level close to the 85% threshold for calibration purposes.

### Sample Preparation

1. Conditioning: Condition fabric samples at approximately 21° C. (70° F.) and 65% RH for 24 hours before testing.
2. Sizing: Cut fabric sample to a uniform size, ensuring it is larger than the measurement area of the fabric tunnel.

### Calibration and Setup

1. Lux Meter and Light Source: Calibrate and position the light source to achieve a stable illuminance of 200 lux across the full area in which the fabric will be placed at the fabric's location at the end of the tunnel. Use the lux meter to verify this level.
2. Light Source Characteristics: The intensity and spread of the light source play an important role. A light source with a wide beam spread might require being placed closer to the fabric to achieve the desired illuminance level uniformly across the sample. Conversely, a more focused or intense light source might need to be placed further away to avoid uneven illumination.
3. Desired Illuminance (200 lux): The specific illuminance level of 200 lux needs to be maintained consistently across the fabric's surface. This requires adjusting the distance of the light source to the fabric to where the light evenly distributes across the entire sample.
4. Light Tunnel Setup: Position the light source within the tunnel, 24 to 36 inches from the fabric to achieve 200 lux luminescence across the entire fabric surface. Position the fabric at the end of the light tunnel and the lux meter on the opposite side of the fabric from the light source at approximately 8 inches.
5. Distance Adjustment: Adjust the distance between the light source and the fabric holder to where preliminary tests have shown uniform illumination of 200 lux across the testing area. As a starting point, positioning the light source approximately 24 to 36 inches (61 to 91.4 cm) from the fabric sample to provide a good balance between achieving the desired illuminance level and ensuring uniform light distribution across the fabric's surface. This recommendation assumes a standard light source without highly specialized optics. To determine the exact distance for your specific setup, consider the following procedure:
(a) Measurement: Use the lux meter to measure the illuminance at the center and edges of the area that corresponds to the size of your fabric samples.
(b) Adjustment: If the illuminance is too high or too low, or if there is significant variability between the center and edges, adjust the distance of the light source accordingly. Move the light source closer if the light is not sufficient or further away if the light is too intense or uneven.
(c) Iteration: Repeat the measurement and adjustment process until you achieve a uniform 200 lux across the entire area of interest.
(d) Uniform Coverage: The goal is to ensure that the entire fabric sample is evenly illuminated. Pay particular attention to maintaining uniform light distribution to avoid hotspots or areas of shadow.
(e) Use of Light Modifiers: Depending on your light source, you may benefit from using diffusers, reflectors, or other light modifiers to achieve a more even distribution of light across the fabric sample.
(f) This approach allows for flexibility in your testing setup and can be adapted to different types of light sources.
6. Control Fabric Test: Conduct a preliminary test using the control fabric to validate the accuracy of the light source and measurement setup.

### Testing Procedure

1. Environment Preparation: Ensure the testing room is darkened, with only the 200-lux light source active. Verify no other light sources are affecting the testing area.
2. Fabric Mounting: Secure a fabric sample in the fabric holder, ensuring complete coverage of the opening and no stretching of the fabric.
3. Illuminance Measurement:
(a) Measure the illuminance (lux) 8 inches behind the fabric sample.
(b) Record the value and calculate the fabric's opacity percentage using the formula:

$$Opacity ( \% ) = ( 1 - ( Measured Light [ Lux ] / Transmitted Light [ Lux ] ) ) \times 100.$$

Repeat Measurements: Conduct the measurement three times for each fabric sample to ensure consistency and calculate the average opacity percentage.

For woven fabrics, opacity, and its opposite measure visible transmittance, may both be related to cover factor as well as the size of the yarn used, and picks per unit length. As those skilled in the art will recognize, fabrics with more open weaves (lower picks per unit length value) and thus lower cover factor values accordingly may allow greater light to pass through resulting in higher visible transmittance values and generally lower opacity values. Conversely, fabrics with tighter weaves (higher picks per unit length values) and thus higher cover factor values allow less light to pass through, resulting in a lower visible transmittance values and generally higher opacity values. The opacity of nonwoven fabrics similarly depends on a variety of factors including most notably the density and method of entangling of the comprising fibers. Note that whether a fabric is woven, knit, nonwoven, a film or other construction, or any combination thereof in whole or in part, opacity is also affected by other factors such as pigmentation and thickness of the fabric or some of its components, materials, or layers, as well as coatings, films or treatments applied thereto. For purposes of the present invention, wherein higher fidelity printed messages and images are desired to be printed on one and preferably both sides of the banner 10 for concurrent display, it is therefore desirable to increase opacity and prevent show-through by using one or more higher opacity layers.

In one embodiment, the rollable fabric of the invention has an opacity value greater than approximately 80%, preferably greater than 90%, and most preferably greater than 95%, and is useable within the range of 80% to 100% depending on the fabric used and/or the application requirements.

Cover factor, as referenced above, is a measurement that may be used to describe the structure of a woven fabric, but in terms of the degree of openness or porosity, and more specifically, the proportion of closed space to total fabric surface area. It thus quantifies the degree to which a fabric conceals or otherwise “covers” the surface beneath it. This value is affected by several factors including, in the case of woven fabrics, ends or picks per unit length, as referenced above, as well as the types of yarn used, each yarn's thickness, the applicable weave pattern, and finishing techniques employed. In general, woven fabrics with a higher value of ends per unit length and/or higher value of picks per unit length, as applicable, and non-woven fabrics having a higher thread density, in either or both directions, will tend to have a tighter weave and thus typically have greater stiffness, and opacity, and a higher cover factor collectively making them less prone to distortions and thus having reduced unevenness particularly across greater distances and less susceptible to show-through. However higher value of ends per unit length, picks per unit length, and thread density, also tends to add areal density which may increase distortions, particularly across greater distances. Conversely, fabrics with a lower value ends or picks per unit length (or thread density) in either or both directions will tend to have a looser weave and thus typically lower areal density, stiffness, and opacity, and lower cover factor making them more prone to distortions, again unevenness particularly across greater distances, and more susceptible to show through. These fabrics may be less suitable for high-quality printing.

Show-through as will be referred to herein describes the phenomenon where a color or pattern on one side of a fabric is visible from the other side. This typically occurs when light passes through the fabric and reflects off the surface or the fibers, creating a faint impression of the image or pattern on the other side. This is generally a result of the fabric having insufficient opacity (or conversely too much visible transmittance) and this may result from factors including, but not limited to, insufficient ends per unit length, insufficient picks per unit length, in one or both directions, insufficient thread density, too low a cover factor value, inappropriate construction or finishing operations, and/or insufficient fabric thickness, as well as use of a too lightly colored fabric for the application. As those skilled in the art will recognize, fabrics having the same areal density may nonetheless exhibit different degrees of show-through and/or stiffness depending on all the foregoing.

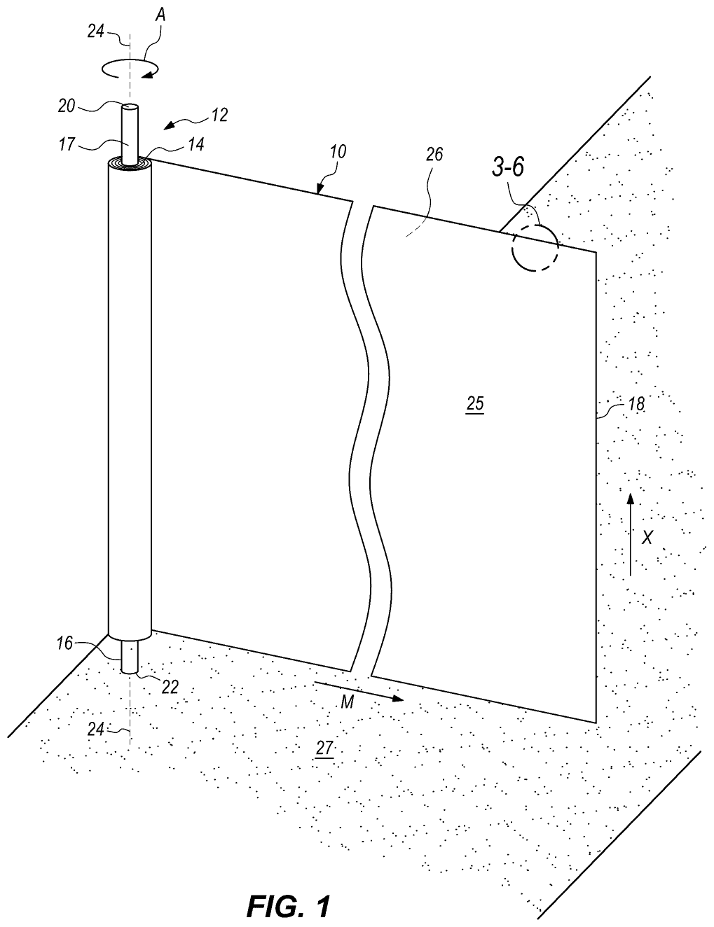

Against this background, dimensional stability may be principally achieved in accordance with the present invention, by providing an improved rollable fabric, preferably an improved rollable fabric for use in a retractable banner assembly wherein the rollable fabric has sufficiently high flexural rigidity in at least one direction, preferably the X direction as shown in FIG. 1 of the drawings, and sufficiently low areal density, to reduce surface contour “distortions” in the fabric such as sagging, rippling, buckling, drooping and curling wherein the fabric has contours and unevenness such that it is not “flat” in one plane. Reduced surface contour distortions promote the fabric to smoothly roll and unroll and orient substantially flat on deployment. Distortions in a rollable fabric in a rollable banner assembly result in increased friction and load on the retraction system resulting in breakage, jamming, and uneven rolling around a central spool. This is particularly the case with longer banner lengths, which also tend to be heavier and when rolled around a spool. To promote higher quality printing of aesthetically pleasing communications, the rollable fabric may optionally further have at least one display surface that is sufficiently smooth and continuous for messages to be effectively printed thereon with no or acceptable show through and/or cover factor. The rollable fabric may be implemented in a retractable banner assembly and further in combination with other rollable fabrics and/or banner assemblies or end points, to define one or more pathways in residential, commercial, and public spaces, indoors and outdoors, route persons or vehicles through such pathways, and block or otherwise inhibit access to designated areas.

With reference to FIG. 1 of the drawings, there is provided a perspective diagram of the improved rollable fabric 10 of the present invention. As indicated above, conventional rollable fabrics are prone to visible surface contour distortions, such as sagging, rippling, buckling, drooping, curling, and the like, when unrolled, deployed, and re-rolled. These distortions, which are generally multi-dimensional as caused by opposing forces such as gravity, air turbulence, tension variations, and the like, individually and collectively create distortions in the corresponding surfaces of the fabric banners, namely unevenness, which distortions are aesthetically unappealing, and when implemented in a banner assembly, in turn hinder the smooth unrolling, deployment and rolling of the same, even across the relatively short distances of some of their intended uses, which distortions impair the visibility of messages that may be printed or otherwise displayed thereon, and often degrade the printed messages as well. Such fabrics may also have insufficient opacity to prevent show through of the messages, particularly in the case of higher-fidelity printing, on one display-side thereof, let alone both sides, which in turn diminishes their aesthetics upon deployment. In keeping with the invention, improved rollable fabric 10 has an improved material structure and orientation with sufficiently high stiffness in at least one direction, and sufficiently low areal density, to provide sufficient dimensional stability to counteract distortions of sagging, rippling, buckling, curling, drooping and the like to facilitate an aesthetically appealing fabric regardless of how the fabric 10 is supported, hung, or otherwise used. When optionally implemented in a banner assembly, the improved rollable fabric 10 further facilitates smooth rolling and unrolling/unfurling of the rollable fabric 10 and improves its ability to remain substantially flat upon deployment whether in combination with a retractable banner assembly or not.

Still referring to FIG. 1, the rollable fabric 10 is accordingly shown incorporated in one exemplary, but not required, embodiment as part of a retractable banner assembly 12 wherein rollable fabric 10 may be unrolled or unfurled or otherwise dispensed from a rotatable core or spool 16 (also referred to as an elongated rotatable mounting rod) in the M direction for use “as is” or for use as a banner or any other suitable use which benefits from reduced distortions or other properties described herein. Depending on the application, retractable banner assembly 12 may optionally include, but is not required to include a housing to enclose the rollable fabric 10 and spool 16 in whole or in part, any suitable winding mechanism (e.g., a hand crank), and/or any suitable biasing means (e.g., spring, or similar mechanical or electromechanical mechanism) operative to apply a biasing torque on spool 16 and thus a retraction tension on the rollable fabric 10. In such case, a threshold pull force will be required to unroll fabric 10 from spool 16 for deployment from a retractable banner assembly. Pull force and retraction tension are counterparts in that pull force is what is exerted by a user when deploying the banner to overcome the retraction tension created by the biasing mechanism. Such biasing means may further cause fabric 10 to roll upon release or decrease of the applied pull force, and preferably, not necessarily, return to a fully rolled storage position around spool 16 upon full release of the applied pull force. Optional retractable banner assembly 12, may be fixed, mountable, portable, self-supporting, anchorless, stanchion based, or incorporate any other form and structure of attachment or combination thereof.

Rollable fabric 10 in a retractable banner assembly 12 of FIG. 1 includes a trailing edge 14 to be coupled directly or indirectly to a rotatable center spool or core 16 for winding or rolling. Rollable fabric 10 further includes a leading edge 18 that is extensible away from spool 16 upon and in response to a pull force to unroll the fabric as indicated above for deployment, and thereafter retractable toward spool 16 upon retraction of the fabric 10. In the most preferred embodiment, the retractable banner assembly comprises a banner, wherein the banner comprises a rollable fabric of the invention.

In one preferred, but not required embodiment, rollable fabric 10 may optionally extend in several embodiments to a full deployment length, preferably in a machine direction, interchangeably referred to herein as the M direction or MD, in the range of from about 2 feet (0.61 meters) to 30 feet (9.14 m) or more, preferably about 3 feet (0.91 m) to about 25 feet (7.62 m), more preferably from about 4 feet (1.22 m) to about 22 feet (6.71 m), and even more preferably from about 6 feet (1.83 m) to about 20 feet (6.1 m), and most preferably from about 7 feet (2.13 m) to about 20 feet (6.1 m). In yet another embodiment, the full deployment length of the rollable fabric 10 from a spool, whether a part of a retractable banner assembly or not, has a length greater than 4 feet (1.22 m), preferably greater than about 5 feet (1.52 m), more preferably greater than about 6 feet (1.83 m) and most preferably greater than 7 feet (2.13 m), up to a maximum of 30 feet (9.14 m).

In another embodiment, the leading and/or trailing edge of the banner has a fabric height that varies depending on intended use. In different embodiments, the height is preferably measured in the cross-machine direction (XD), also interchangeably referred herein as the X direction. The height is preferably at least approximately 2 feet (0.61 m), more preferably at least 4 feet (1.22 m), even more preferably at least 5 feet (1.52 m), and most preferably ranging from approximately 6 feet (1.83 m) to 20 feet (6.1 m). It is further understood that, in some embodiments, the length and height of the rollable fabric may be any combination of the provided ranges. For example, the length in the machine direction (MD) may range from 4 feet (1.22 m) to 20 feet (6.1 m), while the height in the cross-machine direction (XD) may range from 4 feet (1.22 m) to 20 feet (6.1 m). The length and height may be the same or different depending on the application. In one embodiment, the rollable fabric, particularly from a leading and/or a trailing edge, has a length in the M direction and a height in the X direction ranging from 4 feet (1.2 m) to approximately 25 feet (7.62 m), and preferably from 6 feet (1.83 m) to 20 feet (6.1 m). In a more preferred embodiment, the length in the M direction is between 6 feet (1.22 m) and 15 feet (4.6 m), while the height in the X direction ranges from 4 feet (1.2 m) to 10 feet (3.1 m). In yet another embodiment, the rollable fabric may have various shapes including rectangular, square, trapezoidal, triangular, or even partially or fully spherical.

In one embodiment, the invention is directed to a retractable banner assembly comprising a rotatable elongated mounting rod and a banner that is in the range of from about 2 feet (0.61 m) to 20 feet (6.1 m) in the M direction and the height in the X direction is in the range from about 2 feet (0.61 m) to 20 feet (6.1 m), the banner comprising a rollable fabric couplable directly or indirectly to the rotatable elongated mounting rod, wherein the rollable fabric has a stiffness greater than about 17 TABER Stiffness Units, preferably in the range of from about 17 to 190 TABER Stiffness Units, a stiffness in the M direction in the range of from about 5 to about 32 TABER Stiffness Units, and one or more, preferably two or more, and most preferably all, of the following (a) a ratio of stiffness measured in TABER Stiffness Units in the X direction to the M direction of greater than or equal to 1.3 to 1, (b) a thickness in the range of from the range of about 0.1 mm (10 μm) to about 1 mm, (c) a bending length of greater than or equal to 3.5 cm, preferably greater than or equal to 4 cm or 5 cm in the X direction or M direction or both directions, (d) a crease recovery above 90 degrees as measured in either the X direction or the M direction, or both directions, (e) an opacity in the range of from about 90% to 100%, (f) a surface texture in the range of about 0.1 μm to about 5 μm. Other embodiments include the preferred values and ranges discussed throughout this patent specification, printable on both side of the rollable fabric, the banner is either vertically (X direction) or horizontally (M direction), preferably horizontally, extendable or retractable from the retractable banner assembly.

In another embodiment, the stiffness of the rollable fabric of the invention, measured in TABER Stiffness Units in the X direction, is in a range of from about 15 to 30 TABER Stiffness Units, or any whole integer increment therebetween as an upper or lower point of the range. Alternatively, the stiffness may be in the range of 30 to 40 TABER Stiffness Units, 40 to 50 Taber Stiffness Units, or 50 to 500 TABER Stiffness Units, each optionally including any whole integer increment within those ranges as an upper or lower boundary. This stiffness may be combined with any of the following ranges of density: 380 g/m² to 400 g/m², 400 g/m² to 420 g/m², 420 g/m² to 440 g/m², 440 g/m² to 460 g/m², 460 g/m² to 470 g/m², 470 g/m² to 480 g/m², 480 g/m² to 490 g/m², 490 g/m² to 500 g/m², 500 g/m² to 510 g/m², 510 g/m² to 520 g/m², 520 g/m² to 530 g/m², 530 g/m² to 540 g/m², 540 g/m² to 550 g/m², 550 g/m² to 560 g/m², 560 g/m² to 570 g/m², 570 g/m² to 580 g/m², or 580 g/m² to 590 g/m², or any whole integer increment therein as an upper or lower boundary of the range. A combination of any of these TABER Stiffness Unit ranges and areal density ranges may, but is not required to, be further combined with additional rollable fabric properties, including but not limited to, opacity in the range of 80% to 100%, or any whole integer percentage increment therein as an upper or lower boundary of the range, crease recovery in the range of 90 degrees to 180 degrees, or any degree increment therein as an upper or lower boundary of the range, and/or fabric thickness in the range of 0.2 mm to 1.2 mm, or any tenth mm increment therein as an upper or lower boundary of the range. Further, any combination of the above stiffness and areal density ranges, optionally combined with other rollable fabric properties, may also be incorporated with retractable banner assembly parameters, including, retraction tension in the range of 13 Newtons to 89 Newtons, or any Newton increment therein or as an upper or lower boundary of the range, fabric deployment length in the M direction ranging from 100 cm to 700 cm, or any whole cm increment therein as an upper or lower boundary or the range, and/or fabric dimension in the X direction ranging from 60 cm to 600 cm, or any cm increment therein, as an upper or lower boundary of the range. Additionally, in some embodiments, the ratio of Taber Stiffness Units in the X direction to the Taber Stiffness units in the M direction may, but is not required to, be greater than 1.3 to 1, 1.8 to 1 or 2.6 to 1. Similarly, the ratio of Taber Stiffness Units in the X direction to areal density may, but is not required to be, greater than 4.2 to 1, 5.2 to 1 or 6.2 to 1.

In another embodiment, the stiffness of the rollable fabric of the invention, measured in TABER Stiffness Units in the M direction, may be in a range of from about 3.5 to 15 TABER Stiffness Units, or any whole integer increment within that range as an upper or lower boundary. Alternatively, the stiffness may be in the range of 15 to 20 TABER Stiffness Units, 20 to 25 Taber Stiffness Units to 25, or 25 to 42 TABER Stiffness Units, each optionally including any whole integer increment as an upper or lower boundary of the range. This stiffness may be combined with any of the following ranges of areal density: 380 g/m² to 400 g/m², 400 g/m² to 420 g/m², 420 g/m² to 440 g/m², 440 g/m² to 460 g/m², 460 g/m² to 470 g/m², 470 g/m² to 480 g/m², 480 g/m² to 490 g/m², 490 g/m² to 500 g/m², 500 g/m² to 510 g/m², 510 g/m² to 520 g/m², 520 g/m² to 530 g/m², 530 g/m² to 540 g/m², 540 g/m² to 550 g/m², 550 g/m² to 560 g/m², 560 g/m² to 570 g/m², 570 g/m² to 580 g/m², or 580 g/m² to 590 g/m², or any whole integer increment therein as an upper or lower boundary of the range. A combination of any of these TABER Stiffness Unit and areal density ranges may, but is not required to, also be combined with additional rollable fabric properties, including, but not limited to, opacity in the range 80% to 100%, or any whole integer percentage increment therein as an upper or lower boundary of the range, crease recovery in the range of 90 degrees to 180 degrees, or any whole degree increment therebetween as an upper or lower boundary of the range, and/or fabric thickness in the range of 0.2 mm to 1.2 mm, or any tenth mm increment therein as an upper or lower boundary of the range. Further, any combinations of the above stiffness and areal density ranges, optionally combined with other rollable fabric properties, may also be incorporated with retractable banner assembly parameters, including, retraction tension in the range of 13 Newtons to 89 Newtons, or any Newton increment therein as an upper or lower boundary of the range, fabric deployment length in the M direction in range between 100 cm to 700 cm, or any cm increment therein as an upper or lower boundary of the range, and/or fabric dimension in the X direction ranging from 60 cm to 600 cm, or any cm increment therein as an upper or lower boundary of the range. Additionally, in some embodiments, the ratio of Taber Stiffness Units in the X direction to Taber Stiffness units in the M direction may, but is not required to, be greater than 1.3 to 1, 1.8 to 1 or 2.6 to 1. Similarly, the ratio of Taber Stiffness Units in the X direction to areal density may, but is not required to, be greater than 4.2 to 1, 5.2 to 1 or 6.2 to 1.

It is appreciated that as the banner comprising the rollable fabric increases in length or height; the areal density of the fabric becomes increasingly relevant to the total weight of the banner which, if too high, can impeded the retraction, deployment and display of the banner without distortions. This is particularly true in the deployment of retractable banners in orientations which are not vertical. A lighter, lower areal density, rollable fabric may be advantageous for longer banners; however, if the fabric lacks sufficient flexural rigidity, even a very lightweight material may result in fabric distortions and the potential malfunctions in the retractable banner assembly, including uneven roll-up and roll-out. To mitigate these issues, a rollable fabric with higher flexural rigidity may be preferred, particularly when paired with higher areal density. However, if the fabric is too stiff, the retractable banner assembly may fail to operate properly. Conversely, if the areal density is too high, particularly in longer banners, the rollable fabric may become too heavy for effective operation with most typical retraction mechanisms, even if stiffness is reduced. It has been discovered that a balanced combination of physical properties is necessary to ensure optimal performance. In particular, the relationship between flexural rigidity and areal density, whether in the X direction, M direction, or both, must be maintained in light of the retraction tension applied by the biasing torque and the length of deployment for effective operation within a retractable banner assembly. Balancing stiffness, areal density, the dimensions of the deployed banner, and the applied retraction tension can be achieved through a formulaic approach or through experimentation. In a preferred but not required formulaic approach the amount of sag of the fabric is calculated with flexural rigidity and retraction tension considered separately as factors to counteract sag.

In yet another embodiment, in particular where the rollable fabric 10 is used in combination with a spool 16 and within a retractable banner assembly, the leading edge 18 of the rollable fabric 10 or banner is extensible upon and in response to a pull force or forces individually and/or collectively ranging from approximately 3 to 20 pounds-force (about 13.3 N to about 89.0 N), or from 5 to 15 pounds-force (about 22.2N to about 66.7 N), or from 7 to about 14 pounds-force (about 31.1 N to about 62.28N), or from 8 to 12 pounds-force (about 35.6 N to about 53.4 N). In some types of springs used to create retraction tension, the amount of retraction tension produced increases as the spring is further wound as the banner is deployed at increasing lengths. The pull force values provided herein relate to the full range of deployment lengths of banners from a condition of being fully retracted to fully deployed.

In one embodiment, the rollable banner assembly of the invention is directed to the use of a retractable banner comprising a rollable fabric extendible over a distance in the M direction from 4 feet (1.22 m) to 20 feet (6.1 m) and having a height in the X direction from 2 feet (0.61 m) to 20 feet (6.1 m) with a retraction tension in the range between approximately 5 to about 20 pounds-force (about 22.2 N to about 89.0 N), wherein the rollable fabric has an areal density ranging from approximately 260 g/m² to less than 620 g/m², or an areal density ranging from approximately 375 g/m² to 610 g/m², a stiffness ranging from approximately 14 to 190 TABER Stiffness Units, and preferably ranging from 17 to 190 TABER Stiffness Units, in either the X direction, M direction, or both. In additional embodiments, the rollable fabric of the invention has as crease recovery of greater than approximately 80% in the X direction or the M direction, or both directions, and may have an opacity greater than 90%, and a surface texture between approximately 1-10 micrometers. In further embodiments, the rollable fabric of the invention has a bending length greater than approximately 3.5 cm, or greater than 4 cm, preferably greater than 5.1 cm, and more preferably greater than 6.5 cm in either the X direction, M direction, or both, and/or a bending length ranging from approximately 3.5 cm to 22 cm in the X direction, and from 4 cm to about 14 cm in the M direction. In another embodiment, the rollable fabric of the invention has a stiffness ratio, measured in TABER Stiffness Units, of the X direction to the M direction that is greater than or equal to 1.3:1, and preferably greater than approximately 1.75:1.

In keeping with the invention, spool 16 may have any suitable length, shape, thickness, and corresponding profile depending on the desired application and functionality and may comprise any suitable material and structure manufactured through any suitable process. By way of example only and not limitation, spool 16 may therefore comprise as shown, a narrow, elongated, extruded aluminum tube that is at least partially hollow, having a relatively uniform internal cylindrical cross-section, and defined by opposing top and bottom flat ends 20 and 22 respectively. Alternatively, spool 16 may comprise in any suitable combination, a thicker, shorter, tube, rod or dowel having a curved or otherwise irregular shaped core with a non-uniform internal cross-section in whole or in part that may be solid and defined by rounded, curved, or slanted ends or any variation thereof. Accordingly, it is understood that the exterior and visible surface 17 of spool 16 and respective top and bottom ends 20 and 22 may be styled to user preferences in each case independently of the internal cross section of spool 16 without departing from the scope of the invention herein.

Still referring to FIG. 1, spool 16 may be comprised of any suitable original or recycled material again including by way of example and not limitation, any metal, polymer, paper based, ceramic, clay, plastic, wood, or the like, or any combination thereof included any suitable composite material comprising any of the foregoing or additional material or materials. In keeping with the invention, the exterior surface 17 of spool 16 may be smooth as shown or textured in whole or in part, including any etching or deposition of material including coating and/or laminating with any suitable material as desired for protection, ornamentation, and/or to enhance its performance. Rollable fabric 10 and specifically trailing edge 14 thereof may, further be coupled, including removably coupled, directly, or indirectly, internally, or externally, to spool 16 in any suitable manner including through one or more adhesives, fasteners, or intermediate linking structures or components. The coupling may be permanent or temporary. By way of example only, and not limitation, an additional dowel, not shown, may therefore be provided in mechanical communication with trailing edge 14 for placement within or about one or more internal or external channels or raised edges, also not shown, of spool 16 that may be formed thereon at any suitable point thereof through extrusion, coating, or the like. Depending on the intended use of the rollable fabric 10, it may be dispensed from spool 16 to then be sized, cut, or otherwise formed for use as a banner in any way that a banner may be used including in one embodiment as part of a retractable banner assembly.

Upon unrolling and extension for deployment, whether in a substantially horizontal orientation as shown in FIG. 1 or a vertical orientation, not shown, leading edge 18 of rollable fabric 10 unrolls and thus extends from spool 16 in a direction designated by reference letter M, also commonly referred to as the machine or warp direction. Depending on the manufacturing approach however, the M direction shown for use of the fabric can also be the fill or cross-machine direction (X direction). This can happen if in the manufacturing approach the cross-machine direction is sufficiently wide to meet the requirements for the length of deployment of the banner. In this scenario, what presents as the width in manufacturing becomes the length in use. Regardless, direction M shows the direction of unrolling of the fabric and is opposite the direction of rolling or winding on spool 16 and is also substantially perpendicular to a primary or center axis of rotation 24 of spool 16. Accordingly, when the rollable fabric 10 is unrolled in direction M, spool 16 in turn rotates about center axis 24 in the direction designated by reference letter A. In the exemplary embodiment shown where rollable fabric 10 is wound ‘under’ spool 16, direction A will accordingly be clockwise. Conversely, if rollable fabric 10 is wound ‘over’ spool 16, not shown, direction A will be counterclockwise. When rolled and thus retracted, whether to a new deployment position or following completion of deployment and return to a starting position wherein rollable fabric 10 is substantially or completely retracted, leading edge 18 similarly rolls back toward spool 16 in the opposite direction of reference letter M and is wound onto spool 16 again about axis of rotation 24 as spool 16 rotates in the opposite direction from unwinding (i.e., counter-clockwise if originally wound under spool 16 and clockwise if originally wound over spool 16).

As referenced above, rollable fabric 10 minimally has a material structure and orientation with sufficiently high stiffness in at least one direction, and sufficiently low areal density, to provide sufficient dimensional stability to counteract the referenced distortions of sagging, rippling, buckling, curling, drooping and the like to facilitate an aesthetically appealing fabric and when implemented in a retractable banner assembly, to further facilitate smooth rolling and unrolling and improve the ability of the fabric to remain substantially flat upon deployment.

As indicated above, a fabric stiffness is related to its flexural properties, namely a fabric's resistance to bend or flex under a specified force as measured using a suitable stiffness test. Cantilever testing is one commonly accepted method for determining the stiffness of fabrics and will be referenced herein for purposes of the present invention. In cantilever testing a fabric is pushed out beyond the edge of a horizontal platform edge so that it flexes downward under its own weight. The length beyond the platform required for the fabric to flex down to a pre-determined angle is the overhang length and it is measured. The length of overhang of the fabric, or the corresponding bending length, as discussed above, which is half the overhang length, considers areal density and flexural rigidity to define the required stiffness and areal density of the rollable fabric of this invention. However, that bending length along with the areal density of the fabric can also be used to calculate a stiffness by measuring the flexural rigidity of the fabric discussed below.

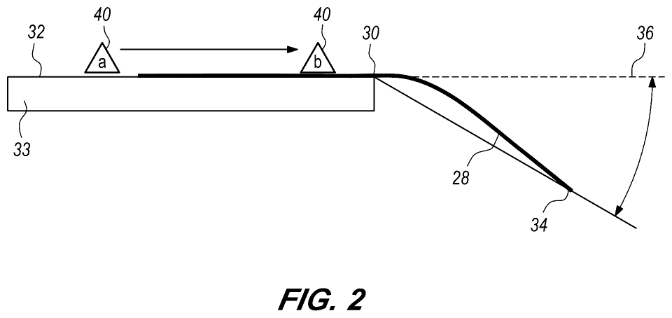

One standard method for measuring flexural rigidity is ASTM D1388, which test is well suited for determining the stiffness of a fabric for purposes of the invention disclosed herein and the appended claims. ASTM D1388 proscribes two alternate methods of calculating stiffness which are, Option A, the “cantilever” test, and Option B, the “heart loop” test. Option A is better suited for use in connection with the disclosed invention and is used to determine the values for flexural rigidity-formula (FRf) disclosed and claimed herein. ASTM D1388, Option A, is performed in summary as follows with reference to FIG. 2 of the drawings. The standard recites: Option A, Cantilever Test—A specimen 28 (i.e., the rollable fabric of the invention) is slid at a specified rate in a direction parallel to its long dimension, until its leading edge projects from the edge 30 of a horizontal surface 32. The length of the overhang is measured when the tip of the specimen designated by reference numeral 34 is depressed under its own mass to the point where a line 36 joining the top to the edge 30 of the platform 33 makes a 0.724 rad (41.5°) angle with the horizontal line 36. From this measured length, the bending length (BL) and FRf are determined as described below. Note that during the testing, a weight 40 moves with the fabric from position “a” to position “b”. As those skilled in the art will recognize, weight 40 is used to stabilize the testing sample and keep the specimen, rollable fabric, flat where it is not beyond the vertical edge or fulcrum 30, beyond which the fabric is cantilevered. The testing steps are as follows:
1. Sample Preparation: A strip (the specimen) of fabric 25 mm×200 mm+/−1 mm (1×8 in+/−0.04 in.) is cut and then conditioned to temperature, pressure, and humidity in accordance with D1776 (a standard atmosphere, typically 21° C. and 65% relative humidity).
2. Preparation of Test Apparatus: The test apparatus is set on a table or bench and confirmed to be level. The bend angle indicator is set to 41.5 degrees.
3. Mounting the Sample: The fabric strip is placed on the horizontal top surface 32 of the tester so that it can be moved lengthwise beyond the surface edge.
4. Measuring the Bending Length: The fabric strip is moved forward so that it bends under its own weight until its leading edge 34 first contacts the bend angle indicator indicating that the fabric's leading edge has reached a point which is 41.5 degrees below the horizontal top surface of the tester. The overhang length is then measured. The bending length (BL) is calculated as ½ the length of the overhang length of the fabric strip at the point when the leading edge of the fabric strip reaches a point on a plain which is 41.5° below the horizontal top surface 36. This can be measured directly using any suitable device.
5. Repeat Measurements: The test is usually repeated several times (the standard recommends at least 20 times for each specimen), and the results are averaged to obtain a representative stiffness value. (As those skilled in the art will know, repeating testing less than 20 times for each specimen may still result in accurate results depending on a variety of factors).
Stiffness, or more precisely, flexural rigidity, can also be determined in TABER Stiffness Units using a TABER Stiffness Tester model 150-E or other similar operating model as may be later introduced by TABER. Most skilled in the art will conclude that TABER Stiffness Units are a measure of flexural rigidity. As used herein this disclosure and appended claims, all references to Taber Stiffness Units will be referred to as a measure of “stiffness” are derived from use of the TABER stiffness tester model 150-E as reference by Taber itself. Stiffness as used here may therefore be synonymous with the property flexural rigidity. While similar, these properties are not the same. Those skilled in the art will recognize that flexural rigidity is a good way to measure the resistance to bending of a fabric for use in the invention described herein. The TABER Stiffness Tester operates by holding a fabric sample of specified dimensions vertically and then applying an increasing force (“torque”) until an established distance or angle of deflection is achieved from which TABER Stiffness Units are determined. More specifically, the instrument utilizes a two-direction pendulum-type weighing system comprising clamp jaws with lower faces positioned on the pendulum exactly on the center of rotation to evaluate material stiffness and flexural strength. This ensures a constant deflection angle for accurate and repeatable results. Both jaws of the specimen clamp are adjustable so that the test specimen can be positioned precisely in the center regardless of the material thickness. In operation, force is applied to the lower end of the specimen by a pair of rollers that are attached to a driving disc positioned directly behind the pendulum. The rollers push against the test specimen and deflect it from its initial vertical position. The test point reading occurs when a pendulum mark aligns with the appropriate driving disc mark (15 degrees used in connection with the innovation herein). The instrument outputs the moment load applied to the test specimen in TABER Stiffness Units (g-cm) wherein 1 TABER Stiffness Unit is equivalent to 98 micro-newton meters (μN-m). Said another way, Taber Stiffness Units (‘TSU’) are defined as the bending moment of ⅕ of a gram applied to a 1½″ wide specimen at a 5 cm test length, flexing it to an angle of 15°. A TSU is the equivalent of one gram-centimeter, and 1 g-cm=98.066 μN-m.

In one embodiment, the stiffness of the rollable fabric of the invention as measured above in TABER Stiffness Units in the X direction is the range of from 30 to 65 Taber Stiffness Units, or in the range of from about 35 to 60 TABER Stiffness Units, or in the range of from about 40 to less than 60 TABER Stiffness Units, or in the range of from about 40 to 55 TABER Stiffness Units, and or an areal density in the range of from about 400 g/m² to about 525 g/m² or an areal density in the range of from 400 g/m² to about 510 g/m².

In another embodiment, alone or in combination with the above TABER measurements in the X direction, the stiffness of the rollable fabric of the invention as measured above in TABER Stiffness Units in the M direction is greater than 4 TABER Stiffness Units or greater than 4.5 TABER Stiffness Units, preferably in the range of 5 to 32 TABER Stiffness Units, more preferably from about 10 to about 32 Taber Stiffness Units, and most preferably from about 12 to about 30 TABER Stiffness Units.

In another embodiment, the stiffness of the rollable fabric is greater than 4 TABER Stiffness Units in the X direction, or M direction, or both, preferably greater than 4.5 TABER Stiffness Units, more preferably greater than 7 TABER Stiffness Units, even more preferably greater than 8 TABER Stiffness Units, and most preferably greater than 9 TABER Stiffness Units. In yet another embodiment, the stiffness of the rollable fabric is in the ranges of from about 14 to about 200 TABER Stiffness Units, or in the range of from about 17 to 190 TABER Stiffness Units, or in the range of from about 18 to 190 TABER Stiffness Units, or in the range of from about 20 to 190 TABER Stiffness Units. In yet another embodiment, the stiffness of the rollable fabric is in the ranges of from about 14 to about 120 TABER Stiffness Units, or in the range of from about 17 to 120 TABER Stiffness Units, or in the range of from about 18 to 120 TABER Stiffness Units, or in the range of from about 20 to 120 TABER Stiffness Units.

Flexural rigidity-converted (FRc) for purposes of this patent specification and appended claims is calculated by multiplying TABER Stiffness Units by 98.066, thus, converting TABER Stiffness Units into FRc measured in μN-m.

Preferably the Flexural Rigidity-calculated (FRc) as used here in this disclosure and appended claims (calculated as follows: Taber Stiffness Units multiplied 98.066), in the X direction, as discussed above, and in one embodiment is in the range between 1500 μN-m and 6,550 μN-m, more preferably in the range between 2000 μN-m and 110,000 μN-m, and still more preferably in the range between 3000 μN-m and 5000 μN-m. In another further embodiment, the rollable fabric having a flexural rigidity-converted (FRc) in the X direction of greater than 3000 μN-m, preferably in the range of 3000 μN-m to about 6500 μN-m, more preferably from about 3200 μN-m to about 6100 μN-m. In another embodiment, the rollable fabric having a flexural rigidity-converted (FRc) in the M direction of greater than 400 μN-m, preferably in the range of 400 μN-m to about 3000 μN-m, more preferably from about 500 μN-m to about 2000 μN-m. In an embodiment, the rollable fabric in one embodiment has a flexural rigidity-formula (FRf) as measured in the X direction or M direction or both, greater than 500 μN-m, preferably greater than 1500 μN-m, or more preferably greater than 2500 μN-m, and even more preferably greater than 3500 μN-m.

In another embodiment, the rollable fabric of the invention has a flexural rigidity-formula (FRf) as defined in this patent specification in the X direction above 3000 μN-m, and/or a flexural rigidity-formula (FRf) in the M direction in the range of from about 1600 μN-m to about 7500 μN-m, preferably from about 1600 μN-m to about 4000 μN-m.

In yet still another further embodiment, the invention is directed to a rollable fabric for use as a retractable banner in a retractable banner assembly, the rollable fabric having a bending length greater than 3.5 cm, preferably greater than 4 cm as measured in either the X direction or the M direction or both directions, and a ratio of the bending length in the X direction to the M direction of greater than or equal to 1.3 to 1.

The stiffness in terms of flexural rigidity of the rollable fabric can be calculated based on the bending length and the weight per unit area (areal density) of the fabric. The formula for purposes of this patent specification and appended claims for calculating FRf in μN-m is WL³ where W is the areal density in μN/m², and L is the length in meters. Areal density which is often measured in g/m² can be converted to μN/m² by multiplying by 9,806.6.

In one embodiment, the rollable fabric has a flexural rigidity-formula (FRf) in the X direction of less than 9000 μN/m, preferably in the range of 3000 μN/m to about 8750 μN/m, more preferably from about 3500 μN/m to about 8500 μN/m. In a further embodiment, alone or in combination with the FRf in the X direction, the rollable fabric having a flexural rigidity-formula (FRf) in the M direction of greater than 400 N-m, preferably in the range of 400 μN/m to about 2000 μN/m, more preferably from about 500 μN/m to about 1500 μN/m. In one embodiment, the rollable fabric of the invention has a flexural rigidity-formula (FRf) in the X direction of less than greater than 2785 μN/m. In yet another embodiment, the rollable fabric of the invention has a flexural rigidity-formula (FRf) in the M direction of greater than 1200 μN/m.

In still yet another embodiment of the invention, the rollable fabric of any of the above embodiments has a flexural rigidity-formula (FRf) as measure in the X direction or M direction or both of greater than 3500 μN-m and an areal density in the range from about 350 g/m² to 450 g/m², preferably from about 450 g/m² to 550 g/m².

In a further embodiment, the invention is directed to a rollable fabric for use as a retractable banner in a retractable banner assembly, the rollable fabric having a ratio of Flexural Rigidity-converted (FRc) as measured in the X direction or M direction or both to an areal density measured in g/m² of at least equal to or greater than 5.1 to 1 or equal to or greater than about 6.1 to 1.

In this and other embodiment of the invention, the rollable fabric has a flexural rigidity-converted (FRc) in the X direction of greater than 2000 μN-m, preferably in the range of 2500 μN-m to about 10,000 μN-m, more preferably from about 3000 μN-m to about 7800 μN-m or a flexural rigidity-converted (FRc) in the M direction of greater than 450 μN-m, preferably in the range of 475 μN-m to about 3500 μN-m, more preferably from about 500 μN-m to about 3000 μN-m, and most preferably from about 650 μN-m to about 2800 μN-m. In another preferred embodiment, the rollable fabric of the invention has a areal density of about 375 g/m² to about 600 g/m², and a FRc in the X direction in the range of from about 1000 μN-m to 10,000 μN-m, preferably from about 2000 μN-m to about 8500 μN-m, and most preferably from about 2500 μN-m to 6500 μN-m and/or a FRc in the M direction in the range of from about 100 μN-m to 4000 μN-m, preferably from about 150 μN-m to about 3750 μN-m, and most preferably from about 400 μN-m to 3500 μN-m.

In still another embodiment, the rollable fabric of the invention has a areal density of about 400 g/m² to about 600 g/m², more preferably from about 450 g/m² to about 590 g/m², and a FRc in the M direction in the range of from about 450 μN-m to 2750 μN-m, preferably from about 475 μN-m to about 2500 μN-m, and most preferably from about 500 μN-m to 2000 μN-m. In another embodiment, the rollable fabric of the invention has a areal density of about 400 g/m² to about 600 g/m², more preferably from about 450 g/m² to about 590 g/m², and a FRc in the X direction in the range of from about 3000 μN-m to 6000 μN-m, preferably from about 3250 μN-m to about 5000 μN-m, and most preferably from about 3500 μN-m to 5000 μN-m.

In a further embodiment of any of the above embodiments,, the rollable fabric having a flexural rigidity-formula (FRf) in the X direction of greater than 1000 μN-m, preferably in the range of 1000 μN-m to about 6500 μN-m, more preferably from about 2000 μN-m to about 15000 μN-m or a flexural rigidity-formula (FRf) in the M direction of greater than 400 μN-m, preferably in the range of 400 μN-m to about 2500 μN-m, more preferably from about 600 μN-m to about 2800 μN-m.

Improved dimensional stability of rollable fabric 10 of the invention in one embodiment, has a bending length (½ of the overhang length), as determined using the ASTM D1388 Option A Cantilever Test referenced above, of greater than about 4 cm as measured in at least one direction, which is preferably aligned with and substantially parallel to the axis of rotation 24 of spool 16 as shown in FIG. 1. In another embodiment, the bending length (BL) of the rollable fabric as measured in the X direction is in the range of from about 3.5 cm or 4 cm to about 22 cm or preferably from about 3.5 cm or 4 cm to about 20 cm, and as discussed above in this patent specification. As noted below, the maximum bending length contemplated by ASTM D1388 is approximately 8 cm to 9 cm because the full sample is 20 cm, and some length of the sample must remain on the horizontal top platform to perfume the test. Bending length values referenced in this application which exceed the practical limitations of ASTM D1388 are determined using the same methodology as proscribed in ASTM D1388 with a longer sample.

At the same time, to allow rollability, in one embodiment, the bending length in the M direction is less than about 12 cm, preferably in the range of from greater than 3.5 cm to about 12 cm, preferably in the range of about 4 cm to 10 cm, and more preferably from about 4.1 cm to about 10 cm, and most preferably from about 4.1 cm to about 8 cm.

Dimensional stability can be enhanced wherein the ratio of bending length in X direction to M direction is greater than or equal to approximately 1.3 to 1 (1.3:1), preferably in the range of from 1.4 and 2 to 1, (1.4 to 2:1), more preferably in the range of from 2.1 and 3.0 to 1 (2.1 to 3.0:1), and still more preferably in the range of from 3.1 and 4.0 to 1 (3.1 to 4.0:1). In yet another embodiment, the rollable fabric has a bending length in the M direction of greater than approximately 3.5 cm, preferably greater than 4 cm, and preferably in the range of from about 3.5 cm to about 22 cm, more preferably in the range of from about 4 cm to about 20 cm. In yet another embodiment, the rollable fabric has any bending length in the X direction such that the ratio of bending length in X direction to M direction is greater than or equal to 1.3 to 1, preferably greater than or equal to 1.5 to 1, more preferably greater than or equal to 1.75 to 1, and most preferably greater than or equal to 2 to 1.

As noted elsewhere herein, in one preferred embodiment, there has no upper limit to the stiffness for the rollable fabric in the X direction since the rollable fabric rolls in the M direction. For this same reason, in some embodiments, there is not an upper limit of the bending length in the X direction, and therefore, the X/M bending length ratio exceeds 4:1 or greater, or even as high as 25:1. Dimensional stability may also benefit where the rollable fabric having an areal density of less than approximately 625 grams per square meter (gsm or g/m²), more preferably less than about 600 g/m², and most preferably less than 550 g/m². Preferably in another embodiment, the areal density is in the range between about 260 g/m² to about 600 g/m², more preferably in the range between 300 g/m² to about 600 g/m², and even more preferably from about 350 g/m² to about 575 g/m², and most preferably from about 350 g/m² to about and 550 g/m², and the bending length in the M direction is greater than 4 cm, preferably greater than about 4.5 cm.

In one embodiment, the full deployment length of the fabric in the M direction is in the range of from about 2 feet (0.61 meters) to 30 feet (9.14 m) or more and has an areal density less than 620 g/m² gsm, more preferably a full deployment length of about 3 feet (0.91 m) to about 25 feet (7.62 m) and an areal density in the range of about 260 g/m² to about 620 g/m² gsm, more preferably a full deployment length of from about 4 feet (1.22 m) to about 22 feet (6.71 m) and an areal density from about 260 g/m² to about 610 g/m², and even more preferably a full deployment in the M direction of from about 6 feet (1.83 m) to about 20 feet (6.1 m) and an areal density from about 300 g/m² to about 600 g/m², and most preferably a full deployment in the M direction of from about 7 feet (2.13 m) to about 20 feet (6.1 m), and an areal density of from 360 g/m² to about 600 g/m². In yet another embodiment, in addition to the full deployment length ranges described, the rollable fabric of the invention has an areal density less than 620 g/m² and a bending length in the M direction greater than 3.5 cm. Additionally, the bending length in the X direction, M direction, or both, may be with a range of approximately 5 cm to 22, or alternatively within a range of 6.5 to 22 cm, 7.5 cm to about 22 cm, 8 to about 20 cm, 8.5 to 22 cm, 9 cm to 22 cm, or 10 cm to 22 cm.

In a preferred embodiment, higher stiffness in the X direction is desirable, whether measured using Taber Stiffness Units (TSU), Flexural Rigidity-Conversion (FRc), or Flexural Rigidity-Formula (FRf). In a most preferred embodiment there is no upper limit to the stiffness of the fabric in the X direction, regardless of whether it is measured in μN-m, TSU or N-m. Dimensional stability may also be enhanced when the rollable fabric 10 has a bending length stiffness ratio in the X direction to the M direction of at least 1.3:1. Stated differently, this ratio corresponds to the X direction exhibiting at least 30% greater stiffness than the M direction, and preferably greater than 40% stiffness, and in some embodiments, more than 600% greater stiffness in the X direction compared to the M direction. In another embodiment, the bending length ratio (X:M direction) is within the range of 1.5:1 to 2:1, or alternatively within the range of 2.5:1 to 3:1, or 3:1 to 4:1, or 4:1 to 6:1.

In keeping with the invention, it is understood that the bending length in the X and M directions referenced herein are relative to the spool regardless of the orientation of the spool to its surroundings (i.e., whether the fabric deploys horizontally, vertically, or otherwise). In further keeping with the invention, it is understood that changes to the spool size and structure, the torque applied to the spool for deployment and/or retraction, as well as the fabric structure, will affect the foregoing flexural rigidity estimates. Dimensional stability of the rollable fabric may be further enhanced when the fabric has a stiffness ratio of Flexural Rigidity-Conversion (FRc) in the X direction to areal density (μN-m:gsm) greater than or equal to approximately 5:1. In some embodiments depending on the fabric type, length, height and orientation, the rollable fabric preferably has a stiffness ratio of FRc in the X direction to areal density within a range of from 5:1 to 14:1 (μN-m:gsm), more preferably 6:1 to 12:1 (μN-m:gsm), and most preferably 7:1 and 11:1 (μN-m:gsm). Additionally, the areal density is preferably with a range of greater than 375 g/m² to less than 600 g/m². Achieving these ratios may be accomplished in different ways. By way of example, in one embodiment, the rollable fabric 10 may optionally include one or more X-direction stiffening fibers.

An additional important property of the rollable fabric is its thickness, which is measured using a micrometer. In one embodiment of the invention, the rollable fabric has a thickness in the range of about 0.1 mm (10 μm) to about 1 mm, preferably from 0.15 mm to about 0.9 mm, even more preferably from about 0.2 mm to about 0.8 mm, yet even more preferably from about 0.25 mm to about 0.7 mm, and most preferably from about 0.3 mm to about 0.6 mm. While maintaining control over other fabric properties, a thinner fabric is generally preferred, as it allows for longer fabric lengths per roll and enhances rolling, unrolling, and display performance. For effective communication, it is desirable that the form and structure of the rollable fabric provide a sufficiently smooth and continuous display surface (25 and/or 26) to enable high-quality printing. This ensures that the fabric has sufficient opacity, typically greater than 70 percent, and preferably within a arrange of 80 percent to 90 percent, more preferably 90 percent to 98 percent, and most preferably 98 percent to 99.99 percent. Alternatively, the rollable fabric may exhibit sufficiently limited visible transmittance, allowing for the effective placement of messages and visual components, including text, graphics, images, advertisements, marketing, wayfinding content, and like communications or communication components to be effectively placed thereon. The foregoing includes but is not limited to, printing, such as by way of example and not limitation, high fidelity printing, to display such messages on display surface 25, and in a preferred but not required embodiment, concurrently on opposing display surface 26 as well. The rollable fabric of the invention imparts dimensional stability with sufficiently reduced fabric surface contour distortions and with sufficiently low fabric weight with sufficient flexural rigidity (FRc or FRf) to collectively reduce distortions, unevenness and tension variances as necessary to promote smooth unrolling and rolling of the rollable fabric 10. The rollable fabric 10 in a preferred embodiment is particularly useful when the rollable fabric is deployed as a banner from a retractable banner assembly and supported at its ends 14 and 18. This preferred embodiment further enables rollable fabric 10 to be deployed with display surface 25 and/or 26 oriented for enhanced viewing, namely substantially flat and thus in a preferred but not required embodiment, substantially normal to a walking surface 27.

As those skilled in the art will recognize, opacity and stiffness are typically increased in fabrics by using more tightly woven and/or thicker materials to reduce transmission of light and resist bending, as applicable, in each case adding material and thus increasing areal density. Therefore, while thicker heavier fabrics may tend to be stiffer and more opaque, one of ordinary skill in the art will appreciate that these parameters along with aerial density and crease recovery must all be properly aligned for achieving the overall dimensional stability to print on surfaces 25 and/or 26 and sufficiently reduce fabric distortions to promote smooth unrolling and rolling.

Surface topography, interchangeably referred to as surface texture, finish, or roughness, is generally understood as the local deviation of a surface from a substantially smooth surface. It is measured using a contact or non-contact-based instrument such as a stylus-based instrument commonly known as a profilometer or a laser scanner or the like (also called a non-contact profilometer), respectively. The greater the deviations, typically measured in micrometers or microinches, the “rougher” the surface. Surface topography is highly dependent on both the structure of a fabric and the process of manufacturing it with acceptable ranges of roughness dependent on the specific application including how the fabric will be implemented, whether it will be printed, and if so, where and through what process.

In keeping with the invention, rollable fabric 10 will also benefit from but is not required to have low surface texture, in whole or in part, on its external visible surfaces 25 and 26 as necessary to promote smooth rolling and unrolling as well as to impart higher print quality. In a preferred but not required embodiment wherein higher fidelity printing is applied on one or both surfaces 25 and 26, printing may have sufficient print quality where such surface texture is less than approximately 10 micrometers, preferably less than 5 micrometers, more preferably less than 3 micrometers and still more preferably less than 1 micrometer as measured using a micrometer. In one preferred embodiment, the rollable fabric of the invention has a surface texture in the range of about 0.1 μm to about 5 μm, preferably from 0.5 um to about 4 μm, even more preferably from about 1 μm to about 3.5 μm, and most preferably from about 1 μm to about 3 μm. It is recognized, however, that the foregoing range may vary accordingly depending on the fabric, method of manufacture, and use of fabric 10, as well as the applicable printing process used, including by way of example and not a limitation, digital printing, ultraviolet (UV) printing, screen printing, sublimation printing, heat transfer printing, block printing, rotary printing, discharge printing, foil printing, pigment printing, direct-to-garment (DTG) printing, transfer printing, reactive printing, water-based printing, flock printing, plastisol printing, foaming printing, burnout printing, embossed printing, resist printing, and photographic printing, and the like. Still further, depending on the use, rollable fabric 10 should not have openings or have sufficiently few and sufficiently small openings in display surfaces 25 and 26, generally correlating to a higher cover factor value on the order probably near 100% to provide the desired smooth and continuous display surfaces 25 and 26 to enable printing thereon, including in a preferred but not required embodiment, higher fidelity printing. However, in some use cases such as in wind, or where there is a desire to see through the fabric, a correct openness factor is needed to balance aesthetics by allowing air and/or light to pass through. In this situation the aesthetics may be acceptably compromised in favor of the overall performance of the banner in the wind or to allow light to pass through. In such applications with an intentional openness factor, opacity may also be reduced, and this may be an intended tradeoff to achieve the purposes of a particular use case. For purposes of this patent specification and appended claims printing quality is measured in pixels per inch (PPI) or pixels per square cm (px/cm), and preferably the quality of printing on the preferred rollable fabric of the invention is greater than 300 pixels per cm (118 px/cm), more preferably greater than or equal to about 600 PPI (236 px/cm), and most preferably greater than about 1200 PPI (472 px/cm).

It should be noted that the above referenced preferred areal density and stiffness values are impacted by a variety of factors including the banner composition, including the type, length, size, weight, and orientation of fibers used, whether the fibers are woven, non-woven, or knit, the number of layers, and the manufacturing process utilized, including whether one or more such layers are coated, laminated, or even embedded in a material. In keeping with the invention, rollable fabric 10 thus structurally comprises at least one rollable layer which in one preferred, but not required, embodiment, further comprises a plurality of fibers and which layer provides the required sufficiently smooth and continuous display surface for the messages to be printed thereon. In an alternate, the at least one rollable layer is a film or sheet, not comprised of fibers, but manifesting and/or contributing to creating the dimensional stability needed as discussed herein. The at least one rollable layer further imparts the required dimensional stability with sufficiently reduced banner distortions promoting the required smooth unrolling and rolling of fabric 10. In addition, to the rollable fabric's deployment with the surface 25 of the rollable oriented substantially flat, and in one preferred, but not required embodiment, substantially normal (parallel) to walking surface 27 as shown in retractable banner assembly 12 of FIG. 1.

It is further understood that the aforementioned preferred values for areal density, stiffness, crease recovery, and opacity are all beneficial to achieving one or more objectives of providing at least one sufficiently smooth and continuous display surface to impart aesthetically pleasing communications, including higher fidelity printed messages on one or both sides of the rollable fabric 10 and to further impart the required dimensional stability to properly orient the display surface for enhanced viewing and enable the fabric to smoothly deploy and retract, particularly across extended distances greater than narrow entryways and the like, when implemented in a retractable banner assembly 12. Changes to these objectives will correspondingly result in different preferred values. By way of example only and not limitation, in the case of retail check-out aisles and the like, where the fabric or banner if incorporated in a retractable banner assembly, may typically span a shorter distance, dimensional stability may be less a factor than the provision of a smooth and continuous display surface. In such a case, some dimensional stability values may be on the lower end of the ranges discussed above.

In alternative, but not required additional embodiments of rollable fabric 10, one or more supplemental rollable layers may be provided and positioned on the first layer, wherein the first layer includes a plurality of fibers, and the one or more supplemental layers function to stabilize the same in whole or in part. In these alternative embodiments, the first and one or more supplemental layers together provide the required sufficiently smooth and continuous display and together impart the required dimensional stability with sufficiently reduced banner distortions to promote the required smooth unrolling and rolling of fabric 10, and to enable its deployment with display surface 25 oriented substantially flat. It is contemplated that, yet additional rollable layers may be provided to achieve the stabilization of the plurality of fibers and to collectively provide the required sufficiently smooth and continuous display surface and further impart the required dimensional stability, opacity, and flat orientation of display surface 25 on deployment of fabric 10.

In keeping with the invention, the stiffness profile of rollable fabric 10 may be isotropic (i.e., uniform in both the M direction and X direction) or preferably anisotropic (i.e., non-uniform). If isotropic, the limit of stiffness in both directions (the direction of rolling/unrolling designated generally by reference letter M and the direction of its height or width, depending on orientation of the banner, designated generally by reference letter X) is determined in the first instance by the requirement that the fabric be flexible enough to roll up. Accordingly, there is a stiffness limitation which depends in part on the diameter of the rolled fabric. In one embodiment, the rollable fabric has a FRc from greater than 400 μN-m to less than 2400 μN-m in the M direction such that the fabric is not prevented from easily rolling and unrolling. The dimensional stability of the fabric making up the banner and its ability to counteract distortions when deployed may also benefit from anisotropic stiffness according to the present invention such that it has greater stiffness in at least one direction generally and in one preferred but not required embodiment shown herein, greater stiffness in the direction X than the direction M, specifically. As shown, in this embodiment, in FIG. 1, direction X is substantially parallel to the center axis of rotation 24 of spool 16 and conversely substantially perpendicular to the M direction of rolling/unrolling of rollable fabric 10, regardless of how the banner is oriented (e.g., substantially horizontally as shown in FIG. 1, vertically, or otherwise). While there is presently understood to be no upper limit in one preferred embodiment, to the amount of stiffness in the X direction, it is understood that the banner's functionality will benefit from a stiffer fabric in the X direction and preferably, but not necessarily, at least 30% stiffer in the X direction than in the M direction.

In one embodiment, the rollable fabric of the invention, in particular for use as a banner in a rollable banner assembly, has a stiffness in both the M direction and the X direction within a range of 5 to 32 TABER Stiffness Units, preferably from approximately 6 to 30 TABER Stiffness Units, more preferably from approximately 7 to 30 TABER Stiffness Units, and most preferably from approximately 8 to 30 Taber Stiffness Units. In yet other embodiment, the rollable fabric has a stiffness in both the M direction and X direction within a range of 10 to 32 TABER Stiffness Units, and preferably from approximately 12 to 30 TABER Stiffness Units. In one embodiment, the rollable fabric of the invention has a stiffness that is identical in both the X direction and the M direction, and within a range of from 5 to about 32 TABER Stiffness Units, preferably where the upper end of the range is less than approximately 30 TABER Stiffness units.

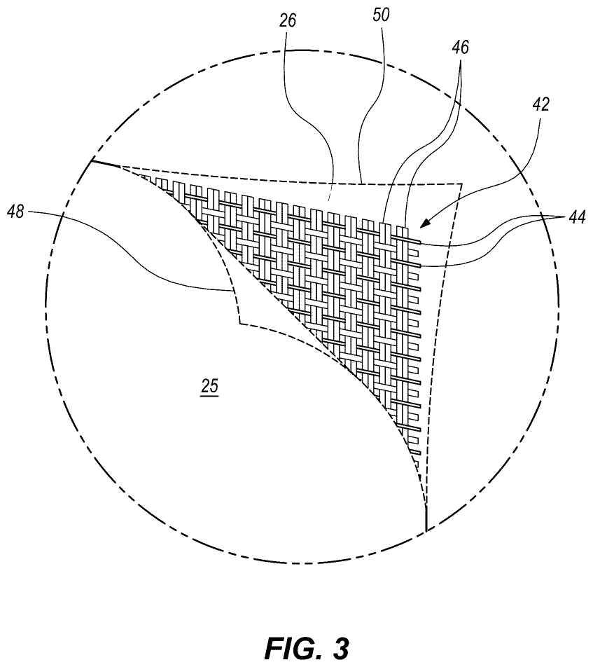

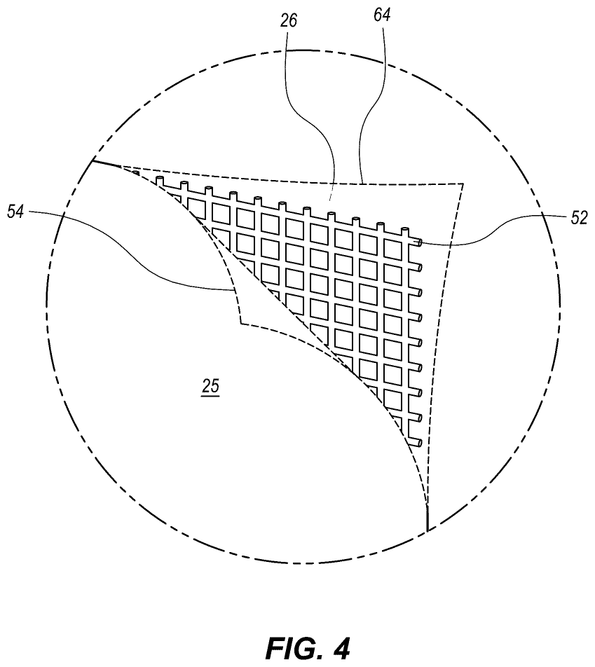

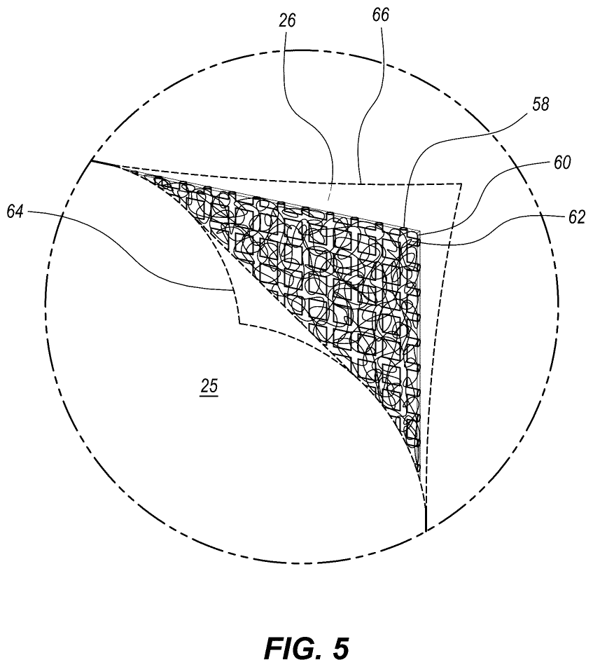

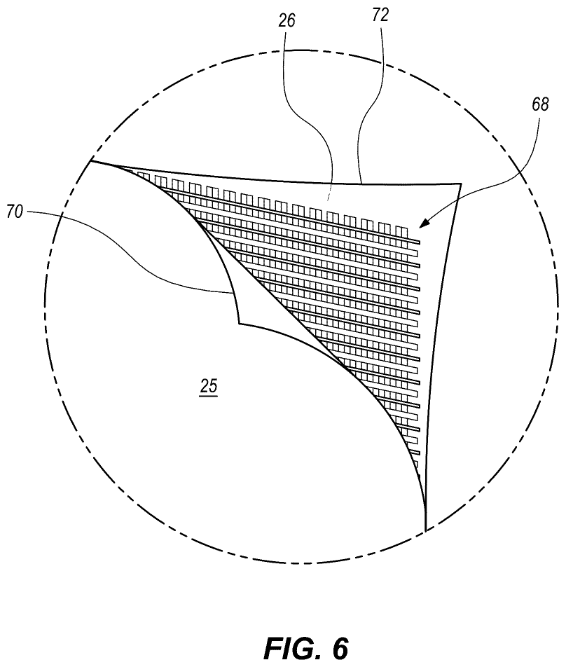

Turning now to FIGS. 3 to 6 of the drawings, there is disclosed various banner structures according to the present invention including a one-directional stiffening fiber substrate wherein the stiffening fiber may be a monofilament, (FIG. 3), an extruded substrate (FIG. 4), a substrate assembly comprising an extruded scrim and non-woven material (FIG. 5), and a laid scrim (FIG. 6). Existing vinyl (PVC coated) fabrics are too heavy and/or insufficiently stiff. Even when the additional weight brings with it additional stiffness, these vinyl fabrics are never stiff enough, particularly in the X direction. Mesh fabrics made using PVC and/or other materials are generally less heavy but have even less stiffness and have the failing of insufficient opacity. Mesh fabrics are also not suitable to receive and display high fidelity printing. Films and multilayer films can have favorable stiffness to weight rations but still lack the overall stiffness required for use especially in a retractable banner assembly and related systems because they droop and sag. Fabrics made in this way using layers without a substrate lack the structure and resulting stiffness needed and are prone to damage. Similarly, all other available options lack at least one, and usually more than one key fabric property to be suitable for use in a retractable banner assembly and related systems intended to communicate high fidelity messaging in an aesthetically pleasing manner.

As shown, in each case, from FIGS. 3 to 6, the substrate or substrate assembly, as applicable, may be, but is not required to be, coated or laminated in whole or in part with one or more layers deposited on either or both sides thereof as necessary for the rollable fabric to (a) have sufficiently low texture, and adequate cover factor and opacity on its external surfaces to achieve the required sufficiently smooth and continuous display surface for messages and/or messaging components to be effectively placed on one or both sides thereof, and (b) achieve sufficiently low areal density, and a sufficient flexural rigidity profile for the intended application, including sufficient bending length and sufficient crease recovery values, to impart the required dimensional stability to reduce unevenness and tension variances as necessary for the display surface to be oriented substantially flat on deployment for enhanced viewing and to promote smooth unrolling and rolling of the banner.

As those skilled in the art will recognize, many different types of substrates may be used in fabrics, and it is understood that any substrate or substrate assembly that achieves the objectives of the present invention will be acceptable. Namely, the structure must provide a rollable fabric having improved physical characteristics, including sufficient dimensional stability, to sufficiently reduce unevenness distortions of the fabric to promote the smooth rolling and unrolling of the fabric whereby to promote deployment of the fabric in an aesthetically pleasing manner with sufficiently reduced distortions such as sagging, rippling, buckling, drooping, curling, and like unevenness to effectively impart communications placed thereon. The monofilament, extruded, non-woven, and laid scrim and substrate assembly structures described in further detail below are exemplary of but not limitations of such suitable rollable fabric of the invention. The key is the rollable fabric of the invention regardless of material or structure requires the balance of properties as discovered herein.

Referring to FIG. 3 of the drawings, a monofilament substrate typically comprises a plurality of monofilament filaments, often manufactured through an extrusion process and having, if desired, a uniform cross section, diameter, and thickness. It should be noted however that it may be desirable to have a non-uniform cross section to promote additional stiffness or to create a better surface for bonding of a laminated film or a coating. It should be further noted that the monofilament can be made through manufacturing processes other than extrusion, and while it can be made of a polymer, other materials are usable such as by example only, metal, a composite material or natural material such as bamboo. Regardless, such monofilament may be woven, knitted, or otherwise interlaced in a suitable manner with each other or with other types of fibers in the substrate. Monofilament substrates are often used in applications where a high level of strength is required. In the context of the current invention however, a monofilament substrate is not used for strength but rather to increase stiffness in the X direction. The monofilament fibers to be used are of proper diameter and material to impart greater stiffness in the X direction than fibers used in the M direction. Through alignment of the monofilament fibers in the X direction and use of other less stiff fibers in the M direction, anisotropic stiffness is achieved with greater stiffness in the X direction. As noted above, continuous multi-filament and mono-filament yarns can be extruded from polymers such as polyester, nylon, and a variety of other materials. These yarns can be used either in continuous filament form or they may be segmented into staple fibers or defined lengths. In the case of a single thread, it may be warp or weft knitted using a conventional interlacing process or woven into fabric using warp (machine direction) and weft (cross-machine direction) yarns. It should be noted that for the purposes of the present invention, it is not required that that X direction fiber members be a monofilament. Any suitable fiber or fiber structure used in the X direction that imparts greater stiffness in the X direction than the M direction will suffice. It should also be noted that monofilament or other stiffening fibers can be used in the M direction as well if it is desired to increase stiffness in the M direction as well, which may also positively contribute to the dimensional stability. As stated above, and it is a key point of the invention herein, stiffness in the M direction is limited to that which will not prevent the rolling of the fabric.

Still referring to FIG. 3, a monofilament substrate indicated generally by reference numeral 42 may be used in accordance with the present invention. As shown, monofilament substrate 42 includes a plurality of filaments 44 each having, if desired, but not required, a uniform cross section, diameter, and thickness that may be woven, knitted, or otherwise interlaced in a suitable manner with fibers 46. Monofilament substrate 42 resists bending in the X direction but allows flexibility in the M direction. Monofilament substrate 42 may be coated or laminated, with one or more layers 48 and 50 as shown, to achieve the required smooth and continuous printing and display surface and impart the required dimensional stability. The specifics of the referenced monofilament design, including diameter and spacing, and stiffness, can be adjusted according to the desired mechanical properties of the applicable fabric keeping in mind that the bending and stiffness will typically increase as the monofilament diameter increases. The filament can be a polymer which can be extruded or made through other processes or other material such as metal or could even be plant based such as bamboo. There is a balance of smoothness of finish, tending toward small monofilaments, and X direction rigidity, tending toward larger monofilaments. In the exemplary, but not required embodiment shown, the filaments 44 have a diameter in the range of 0.10 mm to 0.6 mm, preferably about 0.2 mm to about 0.4 mm. One of ordinary skill in the art will appreciate that larger monofilaments can be used to increase stiffness; however, this leads to a thicker and potentially heavier fabric. Optimally thinner monofilaments with high stiffness are used since this leads to a thinner smoother fabric. The size of the monofilament will also affect the number of monofilaments which can fit within an inch as well as the number required to achieve the desired stiffness. Depending on the stiffness and size of the monofilament, the number of monofilaments per inch (picks per inch ‘PPI’) will vary depending on the desired stiffness and can range from 5 (1.96 picks per cm) to 70 PPI (27.6 picks per cm) or more. Other properties of the rollable fabric 10 including areal density, stiffness, Taber stiffness, flexural rigidity (FRc and FRf), opacity, crease recovery and thickness are all as discuss elsewhere herein. As indicated more, less, or no layers of any suitable material, including but not limited to film, may be laminated to either or both sides of the monofilament substrate 42. Monofilament substrate 42 may similarly be coated in whole or in part with any suitable material including, but not limited to, a polymer, in one or more layers, alone or in combination with the provision of one or more laminated layers. In fact, any, or all the individual filaments and/or woven fibers 44 and 46 may be separately coated in whole or in part before weaving or knitting the same into monofilament substrate 42.

An extruded substrate as shown in FIG. 4 is made through an extrusion process and typically, but not necessarily, fused at its cross points. In this process, molten material which may comprise a variety of different suitable materials including polymers such as polyester, nylon, and polypropylene, may be forced through a die or made in other processes to create a continuous sheet of material. Some modern machinery can extrude and fuse the elements of the substrate in a single near simultaneous process. The resulting substrate may be uniform and/or have consistent thickness throughout, except for the connection points which, if fused as indicated above, will tend to be thicker, depending on the manufacturing process and objectives. To create anisotropic stiffness for purposes of the current invention the extruded scrim can be stretched in the M direction before cooling. As the scrim stretches, the M direction members become thinner and therefore less stiff. Extruded substrates are commonly used as base layers for laminating or coating with additional materials and are useable to achieve the desired stiffness profile and other objectives of the present invention.

Still referring to FIG. 4, a second preferred, but not required, embodiment of rollable fabric 10 is shown which may be used to achieve the required smooth and continuous display surface and to impart the required dimensional stability of the fabric in accordance with the present invention. In this embodiment, there is provided an extruded substrate or center layer 52. One of the advantages of using extruded material for rollable fabric 10 is that it can be engineered to have specific properties of weight and stiffness but also UV resistance or fire retardancy, depending on the needs of the application. Additionally, the extrusion process can be more efficient and cost-effective than producing and weaving individual fibers. Again, in keeping with the invention, this fabric has the same properties as discussed herein. As in the case of the monofilament substrate 42 of FIG. 3, center layer 52 may be optionally laminated and/or coated with one or more layers 54 and/or 64, comprising any suitable material including film and polymer which may be bonded through the substrate's interstices, as necessary to achieve the objectives of the present invention.

A non-woven layer as shown in FIG. 5 can be used on one or both sides of a scrim or other stiffening structure of any type to cover or fill interstices and help in creating a smooth, flat outer surface that is suitable for printing to present messaging in an aesthetically pleasing manner. Similarly, the scrim or other stiffening elements can be imbedded in or entangled with the non-woven. Non-woven materials are fabrics typically created by bonding fibers together without weaving or knitting them into a fabric. Instead of being a woven or knit like traditional textiles, non-woven fabrics are created through a process of engaging such as by way of example but not limitation, depending on the specific non-woven process utilized, entangling, or bonding fibers, either mechanically or chemically, to create a web of interrelated and typically interlocking fibers. There are several different methods for creating non-woven materials, but all involve some form of fiber engagement with the most common methods being spun bonding, melt blowing, needle punching, and chemical bonding. As those skilled in the art will recognize, spun bonding involves extruding filaments of polymer through spinnerets, which are then laid down onto a conveyor belt to form a web of fibers. The fibers are then bonded together using heat or pressure to create a non-woven fabric. Melt blowing involves extruding polymer through a die to create fine fibers, which are then blown by hot air onto a conveyor belt to create a web of fibers. The fibers are then bonded together using heat and/or pressure. Still further, needle punching involves pushing fibers through a web of material using a series of needles, which entangles the fibers and creates a non-woven fabric. Finally, chemical bonding involves applying a chemical adhesive to a web of fibers, which bonds them together to create a non-woven fabric. Non-woven materials are used in a wide range of applications as they have several advantages over traditional woven fabrics. They are often more durable, lightweight, and resistant to tearing. They are also generally less expensive to produce than woven fabrics. Additionally, a suitable nonwoven material with appropriate stiffness and areal density can be used to impart the needed fabric properties for the current invention. The non-woven may but is not required to be coated or laminated to make the surface smoother and more printable.

Still referring to FIG. 5, there is shown an additional preferred, but not required, embodiment of rollable fabric 10 comprising a non-woven substrate assembly 58 including non-woven material 60 and extruded substrate 62. The non-woven 60 may be used in combination with any suitable monofilament, extruded, laid or other substrate possibly embedded or incased within the nonwoven material again as required by the application and functionality and as necessary to achieve the objectives of the present invention. Other strengthening or stiffening elements, such as by way of example and not limitation, a plurality of monofilaments, may also be embedded or inserted within the non-woven to create the needed stiffness profile. In the exemplary alternative embodiment shown in FIG. 5, an extruded substrate or center layer 62 is thus embedded within non-woven material 60 by bonding one or both sides of substrate 62 thereto using heat and/or chemical bonding. This process creates a sandwich-like structure, with the extruded substrate 62 at the center and the non-woven material 60 encasing it on one or both sides. Again, the selection of extruded substrate 62 as an extruded structure is for exemplary purposes only. It being understood that center layer 62 could comprise any other suitable structure embedded or otherwise sandwiched, encasing or inserted within the non-woven material 60 including by way of example, and not limitation, a needled monofilament substrate.

The non-woven encasement provides several benefits to substrate assembly 58 including increased strength, durability, resistance to tearing and abrasion, and most importantly, it creates a more even surface and adds opacity across the interstices of the scrim while adding limited areal density to the assembly. It also helps to prevent extruded substrate 62 from stretching or distorting over time, which can lead to the banner 10 becoming less effective. As in the case of the monofilament substrate 42 of FIG. 3, and center layer 52 of FIG. 4, the non-woven substrate assembly 58 of FIG. 5 may similarly be optionally laminated and/or coated with one or more layers 64 and/or 66, comprising any suitable material including film and polymer to achieve the desired dimensional stability and impart aesthetically pleasing communications. In the context of the invention disclosed herein, a properly engineered non-woven substrate may possess the required properties to alone achieve the objectives of the present invention. If so engineered, the non-woven material 60 may be used on its own without a coating or lamination or even a center layer or extruded substrate 62. Laminations and coatings do however tend to enhance the printability of non-woven materials.

A laid scrim, as shown in FIG. 6, is made from laying or interlacing, as applicable, fibers or yarns that are typically disposed parallel to each other in a specific pattern. Laid scrim can be made from a variety of materials or combinations thereof including natural fibers, synthetic fibers, or a blend of the two, including polyester, nylon, and polypropylene. Laid scrim, depending on several factors, including threads per unit length, may also be less uniform and less strong than extruded substrates, but they offer more flexibility in terms of design and texture. For further context, a traditional substrate is typically, but not necessarily, made using a weaving technique known as a laid weave which involves crossing warp and weft threads over each other in a way that creates small, diamond-shaped holes in the fabric. These holes are what give the substrate its characteristic translucent, see-through appearance. In a laid scrim, the weft threads are dropped on top of or between warp layers, often with a rotating tool to create a grid-like pattern. Unlike a traditional substrate, a laid scrim does not have the small holes created by a leno weave. Instead, the open spaces in the fabric are created by the gaps between the parallel warp threads.

Still referring to FIG. 6, there is accordingly shown and described yet another preferred, but not required, embodiment of rollable fabric 10 comprising a laid scrim 68. As in the case of the monofilament substrate 42 of FIG. 3, center layer 52 of FIG. 4, and non-woven substrate assembly 58 of FIG. 5, laid scrim 68 of FIG. 6 may similarly be optionally laminated and/or coated with one or more layers 70 and/or 72, comprising any suitable material including film and polymer to achieve the desired dimensional stability and impart aesthetically pleasing communications.

In summary, each type of exemplary, but not limiting, substrate referenced above has its own unique characteristics and is suited to different applications depending on the desired properties of the final product as required for the applicable use and functionality. The types of fabric substrates discussed herein provide examples of how a multiple component fabric system can work to achieve the objectives of the current invention. Generally, the substrate will provide most of the stiffness and dimensional stability, and a secondary layer, film or coating flattens and smooths the surface texture and makes the surface printable. Both elements can add opacity. Any substrate, scrim or other component which provides the desired stiffness in at least one direction is contemplated by this invention. The different substrate types disclosed herein may be coated and/or laminated to achieve the desired properties namely, sufficient flexural rigidity, crease recovery, and opacity to enable the smooth extension, deployment, and retraction of the banner and to further enable the effective delivery of aesthetically pleasing communications. While it is likely that both sides of the applicable substrate will be coated or laminated to facilitate the foregoing, including two-sided printing, such as higher fidelity printing, it is possible depending on the application that only one side, or even a portion thereof, will require such coating or laminating. It should be noted that one sided printing that yields lower weight and sufficiently high stiffness still achieves the objective of enabling smooth extension, deployment, and retraction of the rollable fabric without fabric surface distortions (i.e., unevenness) so that the banner will be oriented sufficiently flat with reduced or sufficiently eliminated unevenness distortions upon deployment to effectively display graphics.

Again, it is understood that rollable fabric disclosed herein is not limited to these forms and methods of construction and may for example be formed from one or more solid sheets or films which may be formed through an extrusion or other suitable process provided the resulting banner has sufficient stiffness and opacity and sufficiently low areal density to achieve the desired objectives of providing a sufficiently smooth and continuous display surface for messages to be effectively displayed therefrom and increasing dimensional stability to enable smooth unrolling, deployment, and rolling of the banner.

It should further be noted that extruded substrates of the type described herein tend to have large interstices, so coating alone might not result in the desired continuous surface and in such case, lamination may be a more suitable finishing process whether alone or in combination with coating. As indicated above, a nonwoven may be used as a layer over a substrate to cover the interstices and create a smoother surface. It should further be noted that some nonwovens are in fact printable, so a substrate covered by a thin layer of nonwoven material could be a suitable finished product for the banner depending on the resulting stiffness and opacity. It is also possible that a film could be laminated over the nonwoven if desirable to provide a different outside surface (e.g., texture, color, porosity, opacity, etc.) for printing. Still further, the nonwoven could also be formed around the substrate, including integrally formed, further including its interstices, so that the substrate is essentially embedded within the structure of the nonwoven as referenced herein. It would then be possible to print directly on the nonwoven or any laminated or coated layer applied thereto. Lastly, monofilament fibers may be inserted into the nonwoven through needling or other process, which involves mechanically punching the monofilament fibers into the nonwoven fabric using barbed needles or other suitable punching elements. The result is a composite fabric material that combines the properties of the monofilament fiber and the nonwoven fabric wherein the monofilament fibers structurally hold the nonwoven in place, add opacity, and create a more even surface which may similarly be coated or have one or more laminate layers applied thereto on either or both sides of the substrate.

### EXAMPLES

The following examples are included to demonstrate preferred embodiments of the invention. It should be appreciated by those of skill in the art that the techniques disclosed in the examples which represent techniques discovered by the inventors to function well in the practice of the invention and thus can be considered to constitute preferred modes for its practice. However, those of skill in the art should, considering the present disclosure, appreciate that many changes can be made in the specific embodiments which are disclosed and still obtain a like or similar result without departing from the spirit and scope of the invention. It should be noted that ASTM D-1388 used for the testing herein specifies a sample length of ^{˜}20 cm which leads to a practical limitation of the bending length that can be measured of less than 9 cm (BL=½ the measured length of the overhang). Some example bending length values presented exceed 9 cm and were derived using a longer sample using the same methodology otherwise defined by ASTM D-1388.

### Examples 1-15

Rollable fabrics of the invention were tested for suitability and their properties were measured in accordance with the testing standards set forth in the above patent application. The results from the testing are shown in Table 1 below.

### Comparative Example: 1, 2, and 3

Rollable fabrics using rollable fabrics as above were tested for suitability and their properties were measured in accordance with the testing standards set forth in the above patent application. The comparative rollable fabrics of Comparative Example 1, 2, and 3 (CE-1, CE-2, and CE-3) in Table 1 below illustrate rollable fabrics with an inferior balance of properties in one or more respects as compared with Examples 1-15.

TABLE 1

| | | | | Flexural | | Flexural | | XD |
|---|---|---|---|---|---|---|---|---|
| | | | | Rigidity - | | Rigidity - | | Flexural |
| | | | Taber | XD from | Taber | MD from | | Rigidity |
| | | | Stiffness | Taber | Stiffness | Taber | X to M | (FRc) to |
| | Areal | Fabric | XD | Units | MD | Units | Taber | gsm |
| Example | Density | Thickness | (Taber | (FRc) | (Taber | (FRc) | Units | Ratio (μN · |
| # | (g/m²) | (mm) | Units) | (μN · m) | Units) | (μN · m) | Ratio | m:g/m2) |
| 1 | 565 | 0.45 | 35 | 3,432 | 1.6/4.2 | 157/412 | 9.46 | 6.07 |
| 2 | 490 | 0.43 | 41.5 | 4,070 | 6 | 588 | 6.9 | 8.31 |
| 3 | 482 | 0.48 | 40.2 | 3,942 | 1.6 | 157 | 25.1 | 8.18 |
| 4 | 486 | 0.48 | 45.1 | 4,423 | 11 | 1,079 | 4.1 | 9.10 |
| 5 | 509 | 0.48 | 36.2/34.8 | 3,432 | 2.1 | 206 | 16.7 | 6.74 |
| 6 | 507 | 0.48 | 45.3 | 4,442 | 2 | 196 | 22.7 | 8.76 |
| 7 | 506 | 0.48 | 36.5/41.0 | 3,727 | 3.0/2.7 | 275 | 13.6 | 7.36 |
| 8 | 490 | 0.48 | 46.2/48.5 | 4,609 | 11.6 | 1,138 | 4.1 | 9.41 |
| 9 | 440 | 0.48 | 41.7/59.7 | 4,903 | 22/17.2 | 1,912 | 2.6 | 11.14 |
| 10 | 480 | 0.48 | 41.3/62.4 | 5,001 | 27.4/22.2 | 2,403 | 2.1 | 10.42 |
| 11 | 440 | 0.48 | 42.8 | 4,197 | 11.8 | 1,157 | 3.6 | 9.54 |
| 12 | 480 | 0.48 | 47.8 | 4,688 | 19.1 | 1,873 | 2.5 | 9.77 |
| 13 | 572 | 0.48 | 44.5/37.3 | 4,021 | 4.6 | 451 | 8.9 | 7.03 |
| 14 | 360 | 0.36 | 18.6 | 1,824 | 4.75 | 466 | 3.92 | 5.07 |
| 15 | 620 | 0.51 | 43.2 | 4,236 | 3.25 | 319 | 13.29 | 6.83 |
| CE-1 | 643 | 0.55 | 66.4/70.1 | 6,668 | 3.9 | 382 | 17.4 | 10.37 |
| CE-2 | 642 | 0.55 | 94.5/99.1 | 9,414 | 3.7 | 363 | 25.9 | 14.66 |
| CE-3 | 480 | 0.48 | 63.4/61.2 | 6,080 | 36.1/34.5 | 3,432 | 1.8 | 12.67 |

| | MD | | | | | |
|---|---|---|---|---|---|---|
| | Flexural | | | | | |
| | Rigidity | | Flexural | | Flexural | |
| | (FRc) to | XD | Rigidity | MD | Rigidity - | |
| | gsm | Bending | XD from | Bending | MD from | |
| Example | Ratio (μN · | Length | BL (FRf) | Length | BL (FRf) | |
| # | m:g/m2) | (cm) | (μN · m) | (cm) | (μN · m) | Comments |
| 1 | 0.50 | 9.5 | 4,788 | 4.8 | 5 | Passed. |
| 2 | 1.20 | 10.7 | 5,834 | 5.3 | 8 | Passed well. |
| 3 | 0.33 | NM | NM | 3.8 | 2 | Passed narrowly. |
| 4 | 2.22 | NM | NM | 4.1 | 320 | Passed well. |
| 5 | 0.40 | NM | NM | 3.5 | 213 | Passed narrowly. |
| 6 | 0.39 | NM | NM | 3.7 | 248 | Passed narrowly. |
| 7 | 0.54 | 10.160 | 5,204 | 4.0 | 309 | Passed narrowly. |
| 8 | 2.32 | 11.4 | 7,176 | 5.2 | 688 | Passed well. |
| 9 | 4.35 | NM | NM | 6.4 | 1,105 | Passed well. |
| 10 | 5.01 | NM | MN | 6.2 | 1,121 | Passed well. |
| 11 | 2.63 | 11.4 | 6,443 | 5.6 | 740 | Passed well. |
| 12 | 3.90 | 11.4 | 7,029 | 5.4 | 740 | Passed well. |
| 13 | 0.79 | NM | NM | 4.4 | 493 | Passed well. |
| 14 | 1.29 | 9.2 | 2,756 | 6.0 | 13 | Passed very narrowly. |
| 15 | 0.51 | 10.4 | 6,867 | 4.1 | 3 | Passed very narrowly. |
| CE-1 | 0.59 | NM | NM | 3.8 | 349 | Very poor performance. Failed |
| CE-2 | 0.57 | NM | NM | 3.8 | 348 | Very poor performance. Failed |
| CE-3 | 7.15 | NM | NM | 10.5 | 118 | Very poor performance. Failed |

NM—Not measured. CE—Comparative Examples.

While exemplary embodiments of the invention have been illustrated and described, it is not intended that these embodiments illustrate and describe all possible forms of the invention, and such embodiments are not intended to limit the scope or the application or claims in any way. Rather, the words used in the specification are words of description rather than limitation, and it is understood that various changes may be made, and equivalent structures, features, and functions may be provided, without departing from the spirit and scope of the invention and defined by the following claims.

1. A retractable banner assembly comprising a rotatable elongated mounting rod and a banner, the banner comprising a rollable fabric couplable directly or indirectly to the rotatable elongated mounting rod, wherein the rollable fabric has a stiffness greater than 17 TABER Stiffness Units as measured in an X direction and an areal density less than about 620 g/m².

2. The retractable banner assembly of claim 1, wherein the rollable fabric has a stiffness in the X direction in the range of from about 17 to about 190 TABER Stiffness Units.

3. The retractable banner assembly of claim 2, wherein the rollable fabric has an areal density in the range between 260 g/m² and 620 g/m².

4. The retractable banner assembly of claim 1, wherein the rollable fabric has a bending length greater than 3.5 cm in the X direction or an M direction or both directions.

5. The retractable banner assembly of claim 1 wherein the rollable fabric has a ratio of stiffness in the X direction to an M direction as measured in TABER Stiffness Units of greater than or equal to 1.3 to 1.

6. The retractable banner assembly of claim 5, wherein the rollable fabric has a stiffness in the M direction in the range of from about 5 to 32 TABER Stiffness Units.

7. The retractable banner assembly of claim 5 wherein the rollable fabric has a crease recovery above 90 degrees as measured in either the X direction or the M direction, or both directions.

8. The retractable banner assembly of claim 5, wherein the rollable fabric has a stiffness in the X direction in the range of from about 17 to about 120 TABER Stiffness Units.

9. The retractable banner assembly of claim 1, wherein the rollable fabric has an opacity in the range of from about 90% and 100%.

10. A retractable banner assembly comprising a rotatable elongated mounting rod and a banner, the banner comprising a rollable fabric couplable directly or indirectly to the rotatable elongated mounting rod, wherein the rollable fabric has a stiffness in an M direction in the range of from about 10 TABER Stiffness Units to about 32 Taber Stiffness Units.

11. The retractable banner assembly of claim 10, wherein the rollable fabric has an areal density in the range from about 260 g/m² to about 620 g/m².

12. The retractable banner assembly of claim 10, wherein the rollable fabric has a stiffness in the M direction in the range of from about 12 TABER Stiffness Units to about 32 Taber Stiffness Units, and an areal density in the range of from 260 g/m² to 620 g/m².

13. The retractable banner assembly of claim 10, wherein the rollable fabric has an opacity in the range of from about 90% to about 100%.

14. The retractable banner assembly of claim 10, wherein the rollable fabric has a bending length greater than 3.5 cm in an X direction or the M direction or both directions.

15. The retractable banner assembly of claim 10, wherein the rollable fabric has a ratio of stiffness in an X direction to the M direction as measured in TABER Stiffness Units of greater than or equal to 1.3 to 1.

16. A retractable banner assembly comprising a rotatable elongated mounting rod and a banner, the banner comprising a rollable fabric couplable directly or indirectly to the rotatable elongated mounting rod, wherein the rollable fabric has a bending length greater than 3.5 cm as measured in either an X direction or an M direction, or both, and a stiffness measured in the M direction in the range from about 5 to about 32 Taber Stiffness Units.

17. The retractable banner assembly of claim 16, wherein the rollable fabric has a bending length in the range of from about 3.5 cm to about 22 cm as measured in either the X direction or the M direction, or both directions.

18. The retractable banner assembly of claim 16, wherein the rollable fabric has a bending length in the range of from about 8.5 cm to about 22 cm as measured in either the X direction or the M direction, or both directions.

19. The retractable banner assembly of claim 16, wherein the bending length is in the range of from about 10 cm to 22 cm as measured in either the X direction or the M direction, or both.

20. The retractable banner assembly of claim 16, wherein the rollable fabric has a crease recovery above 90 degrees as measured in either the X direction or the M direction, or both directions.

21. The retractable banner assembly of claim 16, wherein the rollable fabric having a front and an opposing back side is printable on both sides of the rollable fabric.

22. The retractable banner assembly of claim 16, wherein the rollable fabric has a bending length in the X direction in the range of from about 10 cm to about 22 cm, a bending length in the M direction in the range of from about 6 cm to about 22 cm, and an areal density of less than 620 g/m².

23. The retractable banner assembly of claim 16, wherein the rollable fabric has a stiffness in the M direction or the X direction or both directions, in the range of from about 14 to about 120 TABER Stiffness Units.

24. The retractable banner assembly of claim 16, wherein the rollable fabric has a stiffness in the X direction, the M direction or both directions, in the range of from about 17 to about 120 TABER Stiffness Units.

25. The retractable banner assembly of claim 16, wherein the rollable fabric has a ratio of bending length in the X direction to the M direction of greater than or equal to 1.3 to 1.

26. A rollable fabric for use as a retractable banner in a retractable banner assembly, the rollable fabric has a bending length greater than 3.5 cm as measured in either an X direction or an M direction, or both directions, and a stiffness measured in the M direction in the range from about 5 to about 32 Taber Stiffness Units.

27. The rollable fabric of claim 26, wherein the rollable fabric has a bending length in the X direction in the range of from about 10 cm to about 22 cm, a bending length in the M direction in the range of from about 6 cm to about 22 cm, and an areal density of less than 620 g/m².

28. The rollable fabric of claim 26, wherein the rollable fabric has a stiffness in the M direction or the X direction or both directions, in the range of from about 14 to about 120 TABER Stiffness Units.

29. The rollable fabric of claim 26, wherein the rollable fabric has a ratio of bending length in the X direction to the M direction of greater than or equal to 1.3 to 1.

30. A retractable banner assembly comprising a rotatable elongated mounting rod and a banner, the banner comprising a rollable fabric couplable directly or indirectly to the rotatable elongated mounting rod, wherein the rollable fabric has a ratio of Flexural Rigidity-Conversion (FRc) measured in an X direction or an M direction, to an areal density measured in g/m² equal to or greater than 5.1 to 1.

31. The retractable banner assembly of claim 30, wherein the rollable fabric a stiffness measured in the M direction in the range of from about 5 to about 32 Taber Stiffness Units.

32. The retractable banner assembly of claim 30, wherein the rollable fabric has an areal density in the range of from about 260 g/m² to 620 g/m².

33. The retractable banner assembly of claim 30, wherein the rollable fabric has a ratio of FRc measured in the X direction or the M direction, to areal density measured in g/m² equal to or greater than 6.1 to 1.

34. The retractable banner assembly of claim 33, wherein the rollable fabric has a stiffness measured in the M direction in the range from about 5 to about 32 Taber Stiffness Units.

35. The retractable banner assembly of claim 34, wherein the rollable fabric has an areal density in the range of from about 260 g/m² to 620 g/m².

36. The retractable banner assembly of claim 30, wherein the rollable fabric has a flexural rigidity-formula (FRf) as measured in the X direction or M direction, or both, above 2100 μN-m.

37. A rollable fabric for use as a retractable banner in a retractable banner assembly, the rollable fabric has a ratio of Flexural Rigidity-Conversion (FRc) measured in an X direction or an M direction or both directions, to an areal density measured in g/m² equal to or greater than about 5.1 to 1.

38. The rollable fabric of claim 37, wherein the rollable fabric a stiffness measured in the M direction in the range of from about 5 to about 32 Taber Stiffness Units.

39. The rollable fabric of claim 38, wherein the rollable fabric has an areal density in the range of from about 260 g/m² to 620 g/m².

40. The rollable fabric of claim 39, wherein the rollable fabric has a stiffness measured in the M direction in the range from about 5 to about 32 Taber Stiffness Units.
